(19) United States
(12) Patent Application Publication
(10) Pub. No.: US 2026/0146416 A1
(43) Pub. Date: May 28, 2026

(54) A METHOD OF MODIFYING A TERRAIN, A GROUND MODIFIER AND A TERRAIN MODIFICATION LOGGING SYSTEM

(71) Applicant: KINEMATIC APS, Odense M (DK)

(72) Inventor: Lars OVERGAARD, Odense S (DK)

(21) Appl. No.: 19/122,817

(22) PCT Filed: Oct. 19, 2023
(86) PCT No.: PCT/DK2023/050247

§ 371 Date: Apr. 21, 2025

(30) Foreign Application Priority Data
Oct. 19, 2022 (DK) PA202270503

(51) Int. Cl. E02F 9/26; E02F 3/32; E02F 9/20; G06T 17/05

(52) U.S. Cl. CPC E02F 9/261; E02F 3/32; E02F 9/2054; E02F 9/264; G06T 17/05

(57) ABSTRACT

The present invention relates to a system and a method for generating a real-time topographic map with respect to an excavated face of a construction site with a real-time location of a bucket, and calculating a real-time perpendicular distance between the bucket and the excavated face based on the topographic map. Moreover, by comparing a topographic grid point assigning a real-time location of the bucket on the grid point generated to be fitted to predetermined resolution and a real-time location of a bucket, a real-time perpendicular distance of the bucket is calculated and provided to conveniently prevent pitching when drilling a deep place in which a clear view is hardly secured with respect to a drilling surface by an excavator driver.

### FIELD OF THE INVENTION

The present invention relates to a method of modifying a ground surface and to a ground modifier and a system configured to carry out said method.

### BACKGROUND OF THE INVENTION

Terrain/ground modification is an integral part of construction, and often it lays the foundation for further construction work. E.g., most buildings, roads, bridges etc. are built on top of terrain that has been modified in some way. If the terrain/ground modification at a building site is not carried out properly, it may be detrimental to the rest of the construction work. Thus, ensuring that terrain/ground modifications are carried out properly is highly important. Because of this, operators performing terrain/ground modifications therefore often remove or replace more ground material than required, to ensure that the work fulfills the requirements. Hence, the process of performing proper terrain/ground modification is very energy-and time consuming.

### SUMMARY OF THE INVENTION

The inventors have identified the above-mentioned problems and challenges related to modification of terrain, and subsequently made the below-described invention which may improve efficiency of modifying a terrain, as well as automatically establish information that may inform about work progression during the process of performing terrain modification.

The invention relates to a method of modifying a terrain comprising a ground surface; wherein said method comprises the steps of: modifying said terrain to establish a modified terrain and thereby a modified ground surface of said modified terrain; establish a digital modified ground surface representation of said modified ground surface; and automatically storing said digital modified ground surface representation.

By enabling establishment of a digital modified ground surface representation of a modified ground surface and by further providing automatic storing of that digital modified ground surface representation, the modifications made to a terrain may be logged, which is advantageous. Advantageously, the logged digital modified surface representation may be utilized to ensure that a performed terrain modification has actually been performed and that it has been performed properly and, e.g., according to a plan such as, e.g., a construction plan. Furthermore, the automatic storing of the digital modified ground surface representation eliminates the need for manual logging. Thereby, an operator modifying a terrain may, advantageously, give full attention to the actual work with modifying the terrain, which could improve the quality of work and the safety during the work with modifying a terrain. Furthermore, the automatic logging solves the problem with missing data caused by operators forgetting to log data during the work with performing a terrain modification. In addition, the automatic storing may further enable logging with a much higher frequency compared to what could be achieved with manual logging, and so, a much more detailed representation of the actual modification made to a terrain may be achieved with the provided method of the invention. Such detailed representation which may be provided by the automatic storing of digital modified surface representation may be utilized in various advantageous ways. E.g., the digital modified surface representation could be utilized for monitoring during a terrain modification to inform an operator performing the terrain modification of the progression of the terrain modification. The operator may thereby by the digital modified surface representation quickly observe locations where terrain modification has already been carried out, without having to spend time and resources to physically move to that location to observe the terrain modification. Thereby, an operator may spend time and resources more efficiently on modifying terrain that has not yet been modified. Advantageously, the method may thus facilitate a more efficient terrain modification work flow and furthermore, it may reduce energy consumption, by minimizing the distance traveled in, e.g. a motorized tool used to perform a terrain modification.

Checking that a terrain modification, e.g., an excavation work, has been performed properly, e.g., in accordance with a construction plan to ensure correct foundation, stability and safety etc. can be a cumbersome and a time consuming task, since it may require a hole to be dug to a depth corresponding to the planned excavation work. Via the hole, it may be possible to check by manual inspection of the hole if the terrain modification, e.g., removal of a particular type of ground material from the terrain, has actually been performed. Advantageously, the provided method according to the invention may eliminate the need for such highly time and energy consuming check routine, since the automatically stored digital modified surface representation provides information on the performed terrain modification.

A ground surface constitutes a surface of a terrain. The terrain may comprise various kinds of ground material, and it should be understood that in the context of the invention, ground material should be understood in a broad sense. Thereby, ground material may comprise, e.g., soil, clay, sand, gravel, vegetation, rock, but also various kinds of pavements including, e.g., asphalt etc. Hence following, that ground and the ground surface may correspondingly comprise such kinds of materials and/or combinations thereof. A terrain may thus include the conventional understanding of a terrain, i.e. a stable formation of “underground”, but it may also include different types of piles of ground materials which may located on top of a terrain and being reflected by a respective digital ground representation.

In the present context, modifying the terrain should be understood in a broad sense as a process that leads to a modified terrain, meaning that the terrain is different compared to the terrain before it was modified. As an example, modification of the terrain may, e.g., result in a change in the topology of the terrain. A terrain may be changed in a multitude of ways, including by removing material from the terrain by digging, scraping, by compressing the material of a terrain, by pushing material comprised of the terrain from one location to another, by moving material from one location of the terrain to another location of the terrain etc. Such modifications made to a terrain correspondingly modifies (changes) the ground surface of the terrain into a modified ground surface.

A digital modified ground surface representation is a digital representation of a modified ground surface. A digital representation comprises digital samples that resembles the modified ground surface, and which may be handled and processed by a computing device. A digital modified ground surface may also be understood as a representation of what is sometimes referred to with the term as build surface.

Both the digital modified ground surface representation and the digital ground surface representation may typically comprise at least three dimensional position data. The position data may include data specifying a geographical position (sometimes referred to as location) on Earth, and elevation data associated with that geographical position. The geographical position data may, e.g., specify a position on the Earth based on a combination of latitude and longitude, to name a non-limiting example, while elevation data (sometimes just referred as elevation) represent the height at a given geographical location specified by the geographical position data. Elevation may, e.g., be specified relatively, e.g., relative to sea level, e.g., a height above sea level etc. In other words, the geographical position may represent or define a horizontal position. The horizontal location (sometimes referred to as position) may, e.g., be represented by longitude and latitude to name a non-limiting example.

Automatically storing digital modified ground surface representation refers to the process of storing without manually having to initiate and/or performing the storage when the method of the invention is already initiated. In other words, when a digital modified surface representation has been established according to the method of the invention, the storing of the digital modified surface representation is carried out without having to manually initiate and/or performing the storing.

According to an embodiment of the invention, said method comprises a step of establishing a digital representation of a ground surface of said terrain to obtain a digital ground surface representation.

Advantageously, this has the effect that the digital ground surface representation may provide a reference to the digital modified ground surface representation. Thereby, it may be possible to establish work by means of the digital modified ground surface representation relative to the digital modified ground surface representation.

A digital ground surface representation may be interpreted as a digital representation of a ground surface. A digital representation comprises digital samples that resembles the ground surface, and which may be handled and processed by a computing device. The digital ground surface representation is a representation of the ground surface of a terrain before the terrain is modified. Thereby, the digital ground surface representation may advantageously represent a baseline to which a digital modified ground surface may be compared. Advantageously, on comparing the digital modified ground surface representation to the digital ground surface representation of a building site thereby provide a way of establishing work progression on that building site. The digital ground surface representation may be established in various ways.

According to an embodiment of the invention, the digital ground surface representation is based on a preestablished map.

The preestablished map may, e.g., refer to a topographic map or other types of map comprising elevation information. A preestablished map may be established in various ways including, e.g., various types of scans, including, e.g., lidar based mapping.

According to an embodiment of the invention, the digital ground surface representation is based on a manual survey of the ground surface.

According to an embodiment of the invention, said digital ground surface representation is based on a drone scan.

According to an embodiment of the invention, said method comprises a step of displaying said digital modified ground surface representation (26, DMGSR) on a display (23) of a ground modifier (1).

According to an embodiment of the invention, said displaying of said digital modified ground surface representation (26, DMGSR) is performed when an elevation comprised of said digital modified ground surface representation
is lower than an elevation comprised of said digital ground surface representation.

According to an embodiment of the invention, said displaying of said digital modified ground surface representation is performed only for geographical positions of said digital modified ground surface representation that comprises elevation data that is lower than elevation data of said digital ground surface representation at corresponding geographical positions.

Advantageously, this has the effect that only digital modified ground surface representations that represents a modified ground surface that are below the ground surface represented by the digital modified ground surface representation may be displayed and/or visualized. Thereby, digital modified ground surface representations that may not be related to terrain modification may not be visualized and thereby may not disturb an operator utilizing the visualization of the digital modified ground surface representation, which is advantageous. Thus, e.g., when the digital modified ground surface representation is generated based on the position of a tool point, and the tool point is moved around in the air instead of being used for modifying a terrain, the part of the digital modified ground surface representation that would be generated when the tool is above the digital ground surface representation may advantageously not be visualized. E.g. visualized on a display.

According to an embodiment of the invention, said step of automatically storing said digital modified ground surface representation is performed when an elevation comprised of said digital modified ground surface representation is below an elevation of said digital ground surface representation.

According to an embodiment of the invention, said step of automatically storing said digital modified ground surface representation is performed only for geographical positions of said digital modified ground surface representation that comprises elevation data that is lower than elevation data of said digital ground surface representation at corresponding geographical positions.

Advantageously, this has the effect that only geographical positions of a digital modified ground surface representations that are below the ground surface, as represented by the digital ground surface representation may be stored. Thereby digital modified ground surface representations that may not be related to terrain modification may not be stored. e.g., such as when a digital modified ground surface representation is generated based on a position of a tool point and the tool point is moved around at an elevation above the ground surface, which would typically be in the air instead of being using the tool for modifying a terrain.

According to an embodiment of the invention, said step of modifying said terrain comprises moving ground material from one horizontal location to another horizontal location.

According to an embodiment of the invention, said step of modifying said terrain comprises lifting of ground material of the terrain from one horizontal location to another horizontal location.

According to an embodiment of the invention, said step of modifying said terrain is performed by one or more ground modifiers.

In the present context, a ground modifier refers to an apparatus capable of performing a modification to a terrain. Non-limiting examples of a ground modifier comprises: excavator, backhoe loader, crawler loader etc. Advantageously, this thereby has the effect that the step of modifying the terrain is performed by a ground modifier and thereby, hard grueling manual work with modifying terrain by hand or using manual hand tools may be eliminated.

According to an embodiment of the invention, said step of modifying said terrain is performed by a plurality of ground modifiers.

Advantageously, this has the effect that the modification of the terrain may be performed faster, compared to the scenario where only one ground modifier is utilized for terrain modification.

According to an embodiment of the invention, said one or more ground modifiers and/or said plurality of ground modifiers comprises a wheelbase, a body portion and a ground modification arrangement, wherein said ground modification arrangement is moveably fixated to said body portion, and wherein said body portion is capable of rotating 360 degrees with respect to said wheelbase of said ground modifier.

Advantageously, this has the effect that a ground modifier may modify said terrain from various radial angles while staying at the same position om the terrain.

According to an embodiment of the invention, said one or more ground modifiers comprises a ground modification arrangement capable of performing terrain modification outside a radial distance from a center of area of a wheelbase of said ground modifier, wherein said radial distance extends outside above 20 cm outside an edge of said wheelbase, such as extends at least 50 cm outside an edge of said wheelbase, such as extends at least 90 cm outside an edge of said wheelbase, such as extends at least 150 cm outside an edge of said wheelbase, such as extends at least 180 cm outside an edge of said wheelbase, such as extends at least 200 cm outside an edge of said wheelbase.

According to an embodiment of the invention, one or more of said one or more ground modifiers and/or of said plurality of ground modifiers is an excavator.

Advantageously. this has the effect that an excavator is capable of modifying a terrain in a various ways, given its highly flexible terrain modification capabilities.

According to an embodiment of the invention, said ground modifier comprises a global positioning arrangement.

According to an embodiment of the invention, said global positioning arrangement comprises one or more global navigation satellite system receivers configured to obtain global position information of each of said one or more ground modifiers based on a global navigation satellite system.

Advantageously, this has the effect that global position information may be obtained for each one or more ground modifiers.

According to an embodiment of the invention, said global positioning arrangement comprises at least two global navigation satellite system receivers.

Advantageously, this has the effect of providing more efficient global position information, compared to when using only one global navigation satellite system receiver.

According to an embodiment of the invention, said one or more ground modifiers comprises one or more local position sensors configured to obtain local position information.

The local positioning sensors may refer to any sensor, receiver, global navigation satellite system receiver, which may provide information that may be applied to determine local position information.

According to an embodiment of the invention, at least one local positioning sensor of said one or more local positioning sensors is an inertial measuring unit.

Advantageously, this has the effect that the inertial measuring unit may provide accurate/efficient accelerometer data and gyroscopic data, which may provide accurate/efficient local position information.

According to an embodiment of the invention, said step of establishing a digital modified ground surface representation is performed automatically.

Advantageously, this has the effect that the establishing a digital modified ground surface representation does not require any manual actions to be carried out a person.

According to an embodiment of the invention, said digital modified ground surface representation is based on position information obtained from at least one ground modifier of said one or more ground modifiers, and wherein said position information is obtained during said step of modifying said terrain.

According to an embodiment of the invention, said digital modified ground surface representation is based on position information obtained from a plurality of ground modifiers.

Advantageously, this has the effect that it enables the digital modified ground surface representation to represent terrain modifications carried out by multiple ground modifiers. This may be relevant on building sites where a plurality of ground modifiers may collaborate to achieve a certain terrain modification, which is advantageous.

According to an embodiment of the invention, said position information is based on said global position information and said local position information.

According to an embodiment of the invention, said position information represents a tool point position of a tool point of at least one ground modifier of said one or more ground modifiers and/or of each of said plurality of ground modifiers.

Advantageously, this has the effect that the modified digital ground surface representation is based on a tool point position. A tool point may be understood so as to refer to a particular singular point on a tool of a ground modifier or refer to a relevant geometry (i.e. multiple points defining the shape of a tool which is relevant for determining the lowest cut performed by the tool) of the tool when operated, e.g. a 2D or 3D shape of a tool, e.g. a bucket of an excavator. In particular, the tool point may refer to a position on the tool that a ground modifier may use to modify a terrain and/or ground. Advantageously, the tool point position may thereby correspond to a position where at a terrain has been modified. The meaning of an understanding of a tool point is further elaborated on in relation to e.g. FIG. 17a-c.

According to an embodiment of the invention, said position information is sampled during said modification of said terrain. Advantageously, the position information may thereby represent the trajectory of the tool point during modification of the terrain. In other words, the trajectory represents the movements of the tool point during the period where the position information is sampled, such as during the modification of the terrain.

According to an embodiment of the invention, said tool point position is based on global position information, and further based on local position information.

Advantageously, this has the effect that the tool point position may be located at a global position, while at the same time the local position information may improve the precision with which the tool point position may be determined.

According to an embodiment of the invention, said position information of said tool point is determined based on a kinematic model.

According to an embodiment of the invention, said digital modified surface representation comprises a plurality of grid points; and wherein said plurality of grid points each represents an area of terrain.

According to an embodiment of the invention, said grid points comprises elevation data associated with a tool point position of said one or more ground modifiers.

According to an embodiment of the invention, said digital modified ground surface representation comprises geodetic coordinates.

In the present context, geodetic coordinates refer to global coordinates, wherein each of the global coordinates comprises elevation data. The coordinates thereby may describe a position/location in three dimensions. Elevation data may, e.g., specify a height above and/or below sea level. Thereby, the digital modified ground surface representation may be considered a grid structure which is indexed according to the global coordinates.

According to an embodiment of the invention, each grid point of said plurality of grid points of said digital modified ground surface representation comprises an individual index.

According to an embodiment of the invention, said each individual grid point of said plurality of grid points has a grid size of less than 5 square meter, such as less than 4 square meters, such as less than 2 square meters, such as less than 1 square meter, such as less than 0.5 square meter, such as less than 0.3 square meter; such as less than square 0.2 square meter., such as less than 0.1 square meter, such than less than 0.05 square meter, such as less than 0.02 square meter, such as less than 0.01 square meter.

According to an embodiment of the invention, said digital modified surface representation is subdivided into one or more grid tiles each representing an area of a terrain.

According to an embodiment of the invention, a size of said one or more grid tiles are larger than a size of a grid point of said plurality of grid point.

According to an embodiment of the invention, each individual grid tile of said one or more grid tiles represents less than 300 square meter terrain, such as less than 200 square meter terrain, such as less than 150 square meter terrain, such as less than 100 square meter terrain, such as less than 80 square meter terrain, such as less than 50 square meter terrain, such as less than 30 square meter terrain, such as less than 10 square meter terrain, such as less than 5 square meter terrain.

Advantageously, this may have the effect that it enables data processing including, e.g., updating of a digital modified surface representation, to be performed on one or more grid tiles, rather than on the full digital modified surface representation.

According to an embodiment of the invention, said digital modified ground surface representation is stored as an indexed raster representation.

Advantageously, this has the effect that a raster representation enables fast updating compared to other digital representations and fast to retrieve.

According to an embodiment of the invention, said digital modified surface representations is stored as a vector based representation.

According to an embodiment of the invention, said method comprises a step of updating said digital modified ground surface representation when said step of modifying said terrain is repeated.

Advantageously, this has the effect of ensuring that the digital modified ground surface representation is updated as the terrain is being modified, and thereby it represents the actual modified ground surface.

According to an embodiment of the invention, said step of updating said digital modified ground surface representation is carried out when said modified ground surface is modified in a vertically downward direction along the direction of gravity.

According to an embodiment of the invention, said step of updating said digital modified ground surface representation is only carried out when said modified ground surface and/or said ground surface is modified in a vertically downward direction.

According to an embodiment of the invention, said vertically downward direction is a direction having at least a directional component corresponding to the direction of gravity.

It should be understood that the term vertically downward direction may refer to a direction having at least a component corresponding to the direction of gravity. This, e.g., may refer to only updating the digital modified ground surface when a ground modifier is digging deeper in the terrain and/or modified terrain and thereby the ground surface or an already modified ground surface is modified to have a lower elevation. As a non-limiting explanatory example, updating the digital modified ground surface representation may, e.g., occur when a hole is being dug deeper. Further, in this regard, it may be appreciated that the direction of gravity is toward the center of Earth.

It should be understood that in the present context the term only carried out should be understood as the update not being caried out when the modification of the ground surface and/or the modified ground surface is not in a vertical downward direction. Hence, as a non-limiting explanatory example, when filling a hole that is represented by a digital modified ground surface representation with material such that the modified surface associated with the hole is modified to a modified ground surface having a larger elevation, the digital modified ground surface representation may not be updated.

According to an embodiment of the invention, said updating of said digital modified ground surface representation is only carried out when said position information comprises elevation data that is lower than elevation data of a corresponding position included in said digital modified ground surface representation.

According to an embodiment of the invention, said updating of said digital modified ground surface representation is only carried out when said position information comprises elevation data that is lower than elevation data of a corresponding position included in said digital ground surface representation.

According to an embodiment of the invention, said updating of said digital modified ground surface representation is only carried out when said position information comprises elevation data that is lower than elevation data of a corresponding position included in said digital ground surface representation and lower than elevation data of a corresponding position included in said digital modified ground surface representation.

According to an embodiment of the invention, said step of automatically storing said digital modified ground surface representation is performed when said digital modified ground surface representation has been modified in a vertically downward direction.

According to an embodiment of the invention, wherein said step of automatically updating said digital modified surface representation is carried out when a ground modifier modifies said ground surface and/or said modified ground surface to a lower elevation than the elevation represented in the digital modified ground surface representation of said modified ground surface and/or in said digital ground surface representation.

In the present context the physical modification of the terrain is automatically measured, e.g. by motion sensors, image detectors, inertial measuring units, joint angle encoders, GNSS, etc., and/or any practical combination thereof enabling an establishment of a digital representation of how a ground modifier with respective tool(s) physically affects the terrain. The digital representation may preferably be performed automatically and on a run-time basis.

The digital representation may, even if measured as mentioned above, be regarded as an estimation rather than an exact representation of the ground surface insofar this estimation is regarded sufficient for providing a usable digital modified ground surface representation.

According to an embodiment of the invention, said step of automatically updating said digital modified surface representation is carried out when a ground modifier modifies the terrain to have a lower elevation than represented in the digital modified ground surface representation of said modified ground surface and wherein the lower elevation is determined by measuring the tool point position.

By, by updating the digital modified ground surface representation such that it reflects a lowest elevation, advantageously, the digital modified ground surface thereby reflect a bottom of cut.

According to an embodiment of the invention said step of automatically updating said digital modified ground surface representation (26, DMGSR) is carried out when a ground modifier (1) modifies the terrain (14) to have a lower elevation than represented in the digital modified ground surface representation (26, DMGSR) of said modified ground surface (16) and wherein the lower elevation and/or the digital modified ground surface representation (26, DMGSR) is further correlated with a latest elevation of the wheelbase (2).

In the present context the meaning of the latest elevation of the wheelbase includes a relatively primitive one or few point offset corrections invoked by the position of the wheelbase, but it also may include more complex determinations of the position and extent of the wheelbase footprint. In other words, the elevation of the wheelbase may also be represented as a corresponding measured/estimated digital surface representation.

It is thus possible to also update a digital modified ground surface representation on the basis of the elevation of the wheelbase.

In the present context the digital modified ground surface may be updated not only e.g. by measuring the tool point position of a bucket of a ground modifier, but is may also be updated automatically if the position of the ground modifiers wheel base, e.g. the belts of a ground modifier indicates that, at a certain position, ground fill has been added to a certain geographical location after an earlier registered excavation.

According to an embodiment of the invention, said step of automatically updating said digital modified surface representation is carried out when a ground modifier modifies the terrain to have a lower elevation than represented in the digital modified ground surface representation of said modified ground surface, and wherein said digital modified ground surface representation is updated on the basis of input from at least two different ground modifiers.

In an advantageous embodiment, two, three of several ground modifiers, may share the same physical workspace and the updated digital modified surface representation may be regarded as a combined modified surface representation gathering geodetic data from different ground modifiers. In a preferred embodiment at least one of the ground modifiers is an excavator. Besides an excavator, different further ground modifiers could e.g., comprise a compactor, a scraper, a backhoe loaders, crawler loaders, motor graders, trenchers, skid-steer loaders etc.

According to an embodiment of the invention, said step of automatically updating said digital modified surface representation is carried out only when a tool point position of a ground modifier has a lower elevation than a corresponding previously modified digital modified ground surface representation of said modified ground surface.

In other words, in an advantageous embodiment, the digital modified surface representation may be updated if a tool point position is registered to be lower than previously registered tool point positions. This means in practical terms that any movement of the tool point does not necessarily affect the ground surface representation unless it registered to be lower in elevation than the previously registered ground surface. The term corresponding previously digital modified ground surface representation may in the present be understood as referring to a location, e.g., the previous representation being a position that corresponds to the position of the tool point. Hence, when an elevation of a current tool point position at a current location is lower than a previously sampled elevation of a tool point in the same location, the digital modified ground surface may be updated with the new and lower elevation at that location.

This is a practical way of estimating what the current ground surface elevation is in terms of elevation in the vertical direction. This may however also advantageously be correlated with the horizonal extension of the tool point.

In plain words, a current ground surface may be determined to be the lowest the tip of a shovel of an excavator has been during a work process in the vertical direction over the horizontal area modified by the specifically applied shovel/tool. This lowest tip may also be known as the bottom of cut.

According to an embodiment of the invention, wherein said step of automatically updating said digital modified surface representation is carried out only when a tool point position of one or more ground modifiers has a lower elevation compared to an elevation of a corresponding tool point of a previous digital modified ground surface representation. Advantageously, the digital modified ground surface representation may thereby represent a bottom of cut.

According to an embodiment of the invention, said step of automatically storing said digital modified surface representation is carried out when a tool point position of one or more ground modifiers has a lower elevation compared to an elevation of a corresponding tool point of a previous digital modified ground surface representation. Thereby the lower elevation of a tool point may advantageously represent a bottom of cut.

According to an embodiment of the invention, an update frequency determines when said step of updating said digital modified ground surface representation is performed.

According to an embodiment of the invention, said steps of updating and storing said digital modified ground surface representation is based on differential logging.

This is advantageous in that it has the effect that less storage space is required compared to storing a full digital modified ground surface representation each time. Furthermore, differential logging provides possibility for fast retrieval and restoring of stored digital modified ground surface representation. Differential logging refers may refer to a logging where only differences may be stored. Advantageously, differential logging is less prone to error if stored data are missing or corrupted, compared to, e.g., incremental logging.

In the present context, the term logging refers to storing.

According to an embodiment of the invention, said steps of automatically updating and storing said updated digital modified ground surface representation is based on incremental logging.

Advantageously, this has the effect that it does not take up as much storage space as storing using differential logging and as storing a full digital modified surface representation.

In the present context, the term logging refers to storing.

According to an embodiment of the invention, said step of automatically storing said digital modified ground surface representation comprises storing said digital modified ground surface representation on a data server.

According to an embodiment of the invention, said method comprises a step of selecting a ground material type of said modified ground surface; and associating as metadata said ground material type with said corresponding digital modified surface representation of said modified ground surface;

Advantageously, this has the effect that a digital modified ground surface representation may comprise a selected type of ground material. Thereby, the digital modified ground surface representation, advantageously may comprise information on which ground material type that has been modified.

According to an embodiment of the invention, said one or more ground modifiers comprises a ground elevation sensor configured to detect an elevation of a ground surface and/or of a modified ground surface.

According to an embodiment of the invention, when said elevation sensor obtains an elevation in a position that exceeds an elevation in a corresponding positioning registered in said digital modified ground surface representation, said digital modified ground surface representation is updated according to said obtained elevation.

Advantageously, this has the effect that a fill of ground material may be identified based on said elevation sensor.

According to an embodiment of the invention, said digital modified surface representation is shared among said plurality of ground modifiers.

Advantageously, this has the effect that it may enable ground modifiers to obtain information on the modification of a terrain carried out by other ground modifiers.

According to an embodiment of the invention, said digital modified ground surface representation is established based on position information received from a plurality of ground modifiers.

Advantageously, this has the effect that the digital modified ground surface representation may thereby represent modification of a terrain which is being carried out by a plurality of ground modifiers.

According to an embodiment of the invention, said digital modified surface representation is automatically stored on a data server.

According to an embodiment of the invention, said step of establishing a digital modified ground surface representation is performed by a data server based on received positioning information received from said one or more ground modifiers.

Advantageously, this has the effect that ground modifiers does not need to be equipped with computer hardware capable of establishing digital modified ground surface representations and/or digital ground surface representations. This may facilitate cheaper ground modifiers.

According to an embodiment of the invention, said data server is a central data server that is not comprised of said one or more ground modifiers.

According to an embodiment of the invention, a digital modified surface representation established based on a first ground modifier of said one or more ground modifiers and automatically stored on a data server is transmitted from said data server to a second ground modifier and displayed on a user interface.

Advantageously, this may enable a ground modifier to obtain information on the modification of the terrain carried out by another ground modifier. Advantageously, this may provide more efficient work planning when more than one ground modifier is carrying out modification of a terrain.

In the present context, the term user interface is understood to include a computing device having a display. Thereby, when a digital modified ground surface representation is displayed on a user interface, it is understood that it is displayed on the screen of the user interface.

According to an embodiment of the invention, wherein said data server is a cloud server.

According to an embodiment of the invention, wherein digital modified surface representations stored on said data server can be accessed via a distributed user interface.

According to an embodiment of the invention, a representation of said digital ground surface representation is displayed on one or more displays.

According to an embodiment of the invention, said metadata is display on said one or more displays.

According to an embodiment of the invention, at least one display of said one or more displays is positioned on a said one or more ground modifiers.

According to an embodiment of the invention, at least one of display of said one or more displays is comprised of a portable computing device.

The invention further relates to a ground modifier comprising: a wheelbase; and a ground modification arrangement; one or more local positioning sensors configured to provide local positioning information of a position of a tool point of said ground modifier; and a global positioning arrangement configured to provide global positioning information of said ground modifier.

According to an embodiment of the invention, said ground modifier is an excavator further comprising: a motor; a transmission; a body portion comprising a cab; wherein said ground modification arrangement is moveably fixated to said body portion and wherein said ground modification arrangement comprises: a boom; an arm moveably mounted to an end of said boom; and a bucket moveably mounted to an end of said arm.

According to an embodiment of the invention, said ground modifier comprises a tiltrotator configured to rotate a bucket comprised of said ground modification arrangement.

According to an embodiment of the invention, at least one local positioning sensor of said one or more local positioning sensors is an inertial measurement unit (IMU).

Advantageously, this has the effect of providing both accelerometer data and gyroscopic data from one inertial measurement unit, thereby limiting the number of separate units required to determine local positioning information of a ground modifier.

Further advantageously, this has the advantage that local position information may be determined for a specific portion of a ground modification arrangement of, e.g., a ground modifier.

It should be understood that local positioning information pertains to a position of the tool point of a ground modifier. The local positioning information may advantageously be determined relative to a fixed predetermined position on the ground modifier, E.g. the center point of the ground modifier.

Global position information, pertains to a global position of the ground modifier.

According to an embodiment of the invention, said global positioning arrangement comprises one or more global navigation satellite system receivers configured to obtain global position information of said ground modifier based on a global navigation satellite system.

Advantageously, this has the effect that global position information may be obtained for each one or more ground modifiers. An example of a common GNSS system which may be used according to an embodiment of the invention, is the GPS system.

According to an embodiment of the invention, said global positioning arrangement comprises two or more global navigation satellite system receivers.

Advantageously, this enables more precise localization of said ground modifier compared to systems using only one global navigation satellite system receives.

According to an embodiment of the invention, said ground modifier comprises a tool point localizing module configured to determine a tool point position of a tool point, based on local position information received from the local positioning arrangement and based on global position information received from the global positioning arrangement.

According to an embodiment of the invention, said ground modifier comprises a surface determination module configured to establish a digital modified ground surface representation based on a tool point position.

According to an embodiment of the invention, said ground modifier comprises a data storage configured to store one or more digital modified ground surface representations.

According to an embodiment of the invention, said ground modifier comprises a display configured to display one or more digital ground surface representations.

According to an embodiment of the invention, said ground modifier comprises a user interface comprising a display.

According to an embodiment of the invention, said ground modifier comprises a user interface configured to enable a user to select a ground material type of a modified ground surface; and wherein when selecting said selected ground material type, said ground material type is associated with said corresponding digital modified surface representation of said modified ground surface as associated metadata.

According to an embodiment of the invention, said display is configured to display said digital modified ground surface representation.

According to an embodiment of the invention, upon request by a user via a user interface comprised of the ground modifier, said display may display metadata associated with said digital modified ground surface representation.

According to an embodiment of the invention, upon request by a user via a user interface comprised of the ground modifier, said display may stop displaying said digital modified ground surface representation.

According to an embodiment of the invention, when said display is requested by a user via a user interface to not display said digital modified ground surface representation, said digital modified ground surface representation is still automatically stored.

According to an embodiment of the invention, said metadata may comprise a ground material type.

According to an embodiment of the invention, said ground modifier is configured to carry out said method.

A terrain modification logging system comprising: a positioning arrangement implementable on a ground modifier comprising a tool point, and wherein said positioning arrangement comprises one or more local positioning sensors configured to provide local position information associated with said tool point and a global positioning arrangement configured to provide global position information associated with said ground modifier, and a tool point localizing module configured to establish a digital modified ground surface representation of a modified ground surface of a terrain based on said local position information received from said one or more local positioning sensors and based on said global position information received from said global positioning arrangement; a data server configured to receive and store said established digital modified ground surface representation.

According to an embodiment of the invention, wherein said terrain modification logging system is retrofittable on a ground modifier.

According to an embodiment of the invention, wherein said tool point localizing module is implementable on said ground modifier.

According to an embodiment of the invention, said tool point localizing module is comprised of said data server.

According to an embodiment of the invention, said data server is a cloud server.

According to an embodiment of the invention, said data server is positioned external to said ground modifier.

According to an embodiment of the invention, said one or more local positioning sensors are inertial measurement units.

According to an embodiment of the invention, said terrain modification system is configured to perform said method when said system is implemented on a ground modifier.

According to an embodiment of the invention, said digital modified ground surface representation represents a bottom of cut.

According to an embodiment of the invention, said digital modified ground surface representation (26, DMGSR) is based on position information obtained from a plurality of ground modifiers (1), and wherein said method comprises a step of comparing position information obtained from each of said plurality of ground modifiers to select the lowest elevation in each position; wherein said digital modified ground surface representation is established based on said lowest elevation in each position.

Advantageously, this has the effect that irrespective of how many ground modifiers that is working on a building site, the digital modified ground surface representation may represents the bottom of cut. The bottom of cut being, e.g., understood as the deepest cut into the terrain made by a ground modifier.

According to an embodiment of the invention, said method comprises a step of selecting a ground material type of a modified ground surface (16); and labeling said digital modified ground surface representation according to said ground material type of said modified ground surface (16) to establish a labeled digital modified ground surface representation.

Advantageously, this may have the effect that layers of ground material type may be associated with the digital modified ground surface representation.

According to an embodiment of the invention, said method comprises a step of storing said labeled digital modified ground surface representation when another ground material type is selected; and a further step of generating a second digital modified ground surface representation associated with a current bottom of cut and associating said another ground material type with said second digital modified ground surface representation to establish a second labeled digital modified ground surface representation. Advantageously, this may have the effect that a record of labeled digital modified ground surface representations may be established. Thereby it is possible to inspect what type of material that has been removed at which elevation/depth. It may further be possible to assess the depth of each of the labeled digital modified ground surface representations, which represents layers of specific ground material that has been excavated. This inspection may make the step of inspection of earthworks by digging holes to be inspected obsolete.

According to an embodiment of the invention, the method may comprise a further step of storing said second labeled digital modified ground surface representation.

In an embodiment the invention the method comprises a step of selecting a ground material type of a modified ground surface (16); and labeling said digital modified ground surface representation according to said ground material type of said modified ground surface (16) to establish a labeled digital modified ground surface representation.

In an embodiment the invention the method comprises a step of storing said labeled digital modified ground surface representation when another ground material type is selected; and a further step of generating a second digital modified ground surface representation associated with a current bottom of cut and associating said another ground material type with said second digital modified ground surface representation to establish a second labeled digital modified ground surface representation.

In an embodiment the invention the tool point position is determined on the basis of geometry of the tool point of a tool of a ground modifier.

In an embodiment the invention a digital modified ground surface representation is obtained on the basis of the geometry of the tool point of a tool of a ground modifier and its measured movement relative to a digital ground surface representation about to be modified.

### THE DRAWINGS

Various embodiments of the invention will in the following be described with reference to the drawings where

FIG. 1 illustrates method steps according to an embodiment of the invention,

FIG. 2a illustrates a schematical side view of a terrain with a ground surface,

FIG. 2b illustrates a schematical side view of a terrain with a modified ground surface,

FIG. 3 illustrates a schematical view of a digital modified ground surface representation according to an embodiment of the invention,

FIG. 4 illustrates an exemplified embodiment of a grid tile according to an embodiment of the invention,

FIG. 5 illustrates a schematical side view of an excavator according to an embodiment of the invention,

FIG. 6 illustrates a schematical top view of an excavator according to an embodiment of the invention,

FIG. 7 illustrates a schematical side view of an excavator comprising a tiltrotator and a user interface, according to an embodiment of the invention,

FIG. 8 illustrates a terrain modification system according to an embodiment of the invention,

FIG. 9 illustrates a schematical representation of a visualization of digital modified ground surface representations and a ground surface representation according to an embodiment of the invention,

FIG. 10a and FIG. 10b illustrate side views of a terrain comprising a ground type material according to an embodiment of the invention,

FIG. 11 illustrates communication between two ground modifiers via a data server according to an embodiment of the invention,

FIG. 12 illustrates communication between two ground modifiers according to an embodiment of the invention,

FIG. 13 illustrates two communicating ground modifiers each comprising a tool point localizing module and a data server according to an embodiment of the invention,

FIG. 14 illustrates communication between a data server and a plurality of ground modifiers working at two different terrains according to an embodiment of the invention,

FIG. 15 illustrates a data server according to an embodiment of the invention,

FIG. 16a and FIG. 16b illustrate digital modified surface representations resenting excavation and ground fill, respectively, according to an embodiment of the invention and where

FIG. 17a-c illustrate the meaning of a tool point applied in embodiments of the invention.

### DETAILED DESCRIPTION

The following section comprises a detailed description of the invention with reference to the figures.

The description comprises nonlimiting examples of embodiments of the invention. Details such as specific methods and system structures are provided to give an understanding of embodiments of the invention. Note that detailed descriptions of well-known methods, systems, devices, circuits, components including e.g. control leads, etc. have been omitted so as to not obscure the description of the invention with unnecessary details. It should be understood that the invention is not limited to particular examples described below, and that a person skilled in the art may choose to implement the invention in other embodiments without these specific details. Furthermore, it should be understood that the skilled person may choose to combine features of the described embodiments and of the illustrated embodiments of the invention. As such, the invention may be designed and altered in a multitude of varieties within the scope of the invention, as specified in the claims.

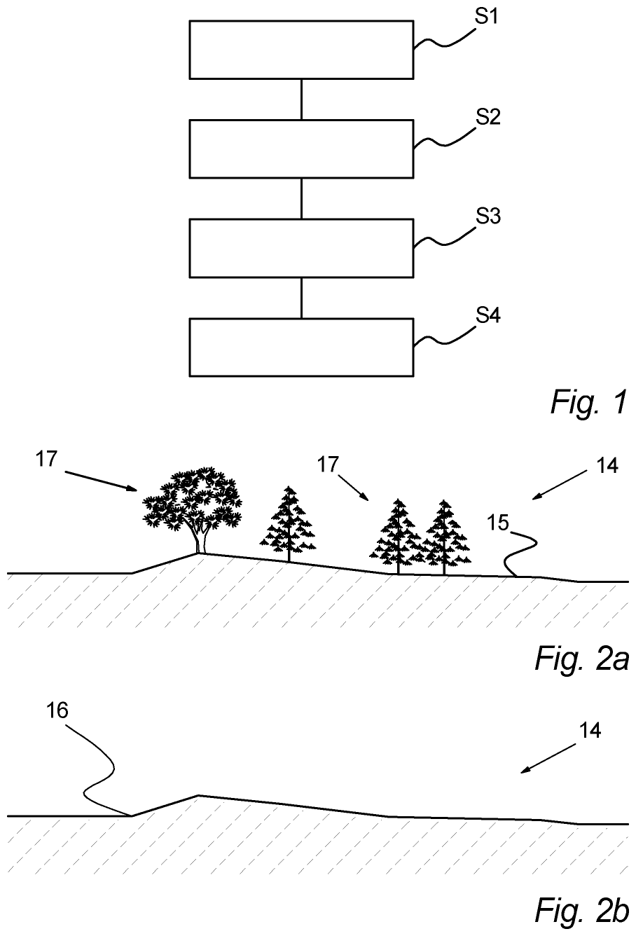

FIG. 1 illustrates method steps S1-S4 of a method of modifying a terrain, according to an embodiment of the invention. A ground surface may constitute a surface of the terrain, and the terrain may comprise various kinds of material, including, e.g., soil, clay, sand, gravel, vegetation, rock, asphalt, etc. Hence following, that the ground surface may correspondingly comprise these various kinds of materials. The method may be carried out in various different ways as will be described in further details in the following sections.

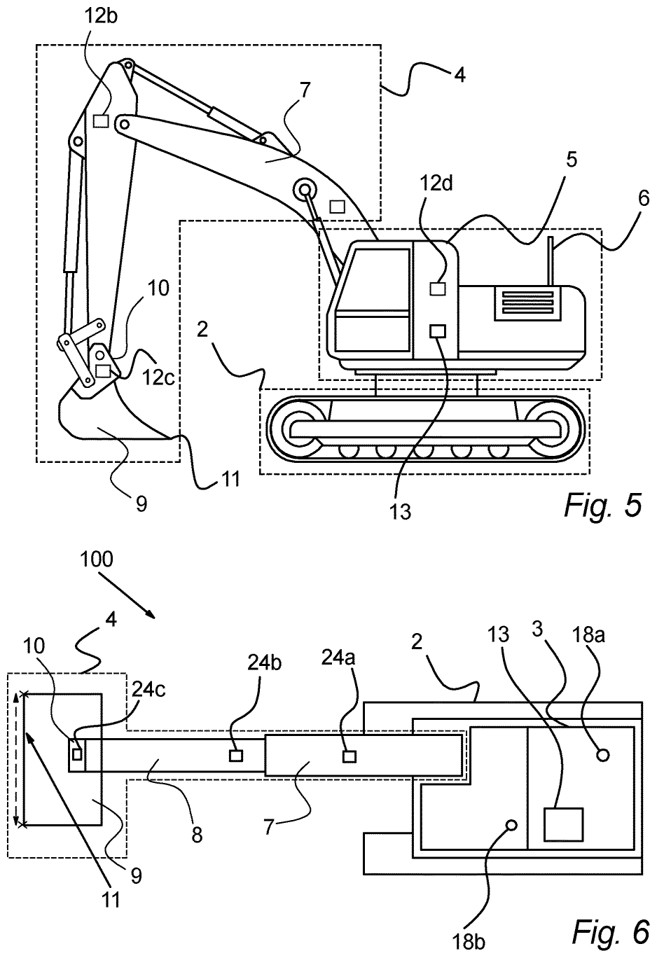

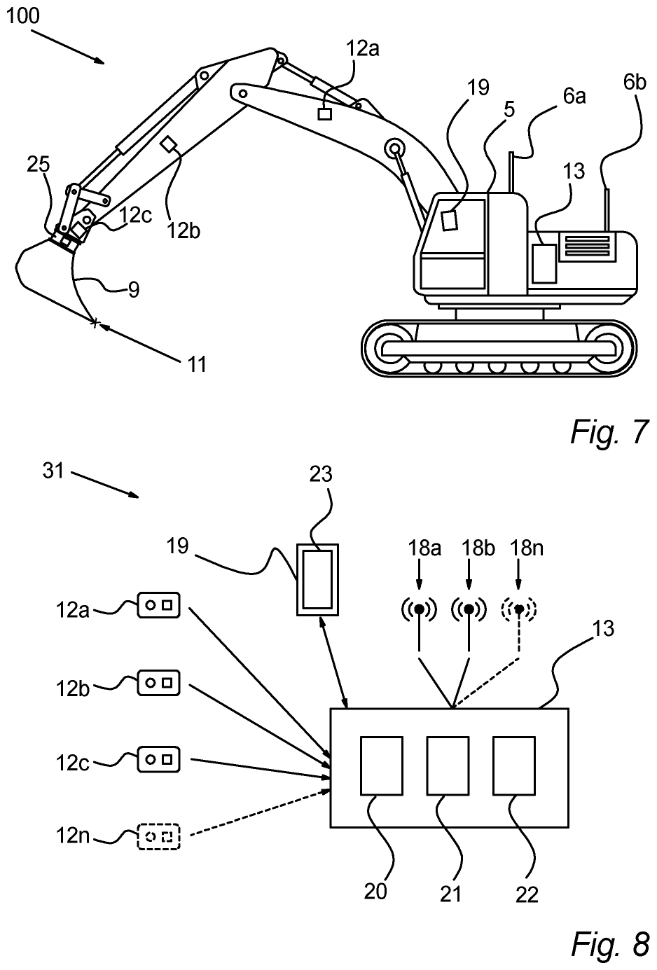

In a method step S1, the terrain is modified to establish a modified terrain and a modified ground surface of said modified terrain. In this example, the modified ground surface is a result of a physical modification of the terrain. The physical modification of the terrain could be carried out in many ways and using various tools and/or apparatuses including. e.g., the ground modifiers illustrated in FIG. 5, FIG. 6 and FIG. 7, respectively.

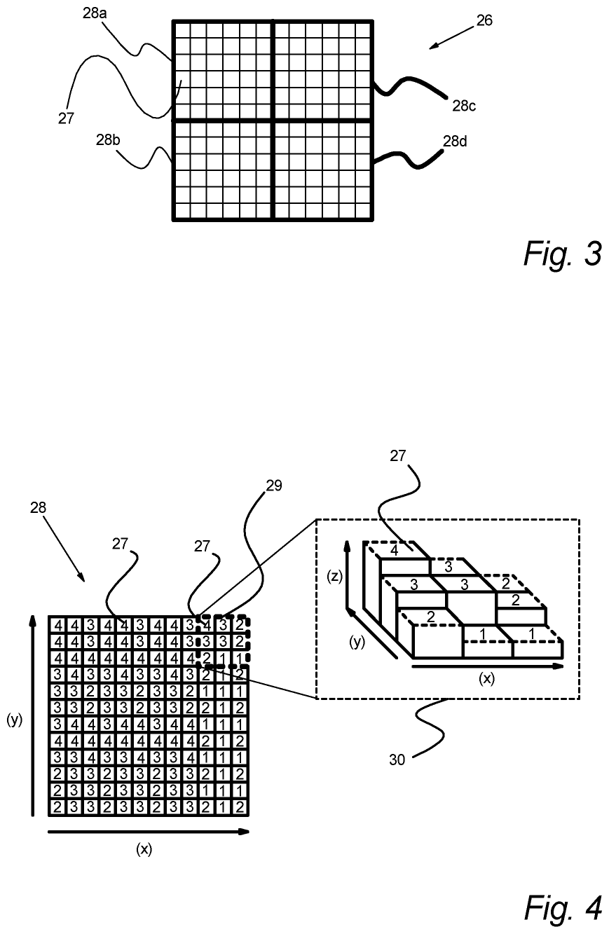

In an additional method step S2, a digital modified ground surface representation of the modified ground surface is obtained. According to the invention, digital modified ground surface representation could be represented in many different ways, further including raster representation, different kinds of vector based representations, analytical based etc. An exemplified embodiment of a digital modified ground surface representation is illustrated in FIG. 3.

In a further step S3, the digital modified ground surface representation is automatically stored. Advantageously, this may optionally allow retrieval of the stored surface representation, and thereby, it may be possible to assess the modified ground surface via the stored digital modified ground surface representation.

Depending on the implementation of the invention, the method steps S1-S3 of the method of modifying a ground surface described in relation to FIG. 1 may be performed in various different ways. E.g., the method may be performed by a ground modifier such as the ground modifiers illustrated in FIG. 5, FIG. 6 and FIG. 7, respectively, and e.g. a ground modifier using the exemplified system illustrated in FIG. 8.

In an optional method step, a digital representation of a ground surface of a terrain is established to obtain a digital ground surface representation.

FIGS. 2a and 2b illustrate a schematical side view of a terrain according to an embodiment of the invention. Specifically, FIG. 1 illustrates the terrain 14 before it has been modified, while FIG. 2b illustrates the terrain 14 after the terrain has been modified to become a modified terrain The modification of the terrain may be performed, e.g., using a ground modifier, including the ground modifiers illustrated in FIG. 5, FIG. 6 and FIG. 7, respectively, and using the method described in relation to FIG. 1, which illustrates the method steps S1-S4.

In FIG. 2a, the terrain 14 comprises an example of a ground surface 15. In this example, the ground surface 15 of the terrain 14 includes vegetation 17.

FIG. 2b illustrates the terrain 14 after it has been modified. After modification, the terrain 14 comprises a modified ground surface 16. In this exemplified embodiment of the invention, the modification has resulted in removal of the vegetation 17.

A digital modified ground surface representation may be established for the illustrated modified ground surface based on the method illustrated in FIG. 1

Optionally, the digital modified ground surface representation may represent the deepest point(s) where the tool point(s) of a ground modifier used for modifying the terrain has been in each location. This deepest point may also sometimes be referred to as the bottom of cut.

Optionally, the digital modified ground surface representation may represent the deepest surface determined based on the deepest position a tool point of a ground modifier has been in each location. In other words, the deepest surface may represent the bottom of cut. The tool point may be defined according to a cut of a tool point. E.g. the tool point may represent a width of the cutting edge of a bucket of the ground modifier. Thereby, the tool point e.g. represents the cutting edge of an actual tool of a ground modifier used for modifying a terrain. The tool point may also be defined in terms of the shape of the tool point, e.g. the shape of a cutting edge of a bucket of a ground modifier. Moreover, the shape of a tool point may define the digital modified ground surface representation. E.g. if the tool point is defined as a curved shape, the digital modified ground surface representation may represent a curved shape. The tool point may thus be defined in two dimensions, but it may also be defined in three dimensions according to different implementations or embodiments of the invention. The tool point may also optionally simply be defined as a point on the tool used for modifying ground.

Optionally, the digital modified ground surface representation may represent the deepest bottom of cut of a plurality of ground modifiers.

FIG. 3 illustrates a schematical view of an exemplified digital modified ground surface representation according to the invention.

The digital modified ground surface representation is a representation of a modified ground surface such as the modified ground surface illustrated in FIG. 2b. The illustrated digital modified ground surface 26 comprises 144 grid points 27, which in this example is subdivided into four grid tiles 28a,28b,28c,28d, each comprising 36 grid points. This subdivision into grid tiles may be different in other embodiments of the invention. The digital modified ground surface representation may expand to include further grid points as the ground modifier moves around the tool point. Other digital modified ground surface representations may thereby be larger or smaller and comprise fewer or more grid tiles and grid points. A grid point may e.g. be understood as a representation of a cell having dimensions, e.g. a size. The dimension of the grid tile may be varied to be larger or smaller than an exemplified grid size of this embodiment. Hence, each grid point may represent information of a modified ground surface. E.g. a grid point may represent an area of a modified ground surface. Each grid tile 28 represents a portion, such as an area of a modified ground surface of a terrain. In this example, each grid point has a grid size of 0.01 square meter, meaning that each grid point represents 0.01 square meter of a modified ground surface. The dimensions (sometimes referred to as a size) of the individual grid tiles 28a-d represent a larger area of a terrain compared to the grid points 27. In this example, each grid tile represents 0.36 square meter, which corresponds to 36 grid points. However, in other implementations of the invention, the dimensions of the grid tiles may be smaller or larger. A digital modified ground surface representation may have fewer or more grid points than what is exemplified in this embodiment. The grid size may be varied, and the amount of grid points per grid tile may also be varied to be larger or smaller than what is exemplified in this exemplified embodiment of the invention.

In some optional embodiments of the invention, a digital modified ground surface may be updated and stored per grid tile, even if said digital modified ground surface is larger than a grid tile. This may sometimes also be referred to as tile wise update. This has the advantage that the full digital surface representation does not need to be updated, which may reduce data transfer and processor demands required for updating the digital modified ground surface. The dimension of a grid tile may vary depending on the implementation of the invention. Thus, a grid tile may, e.g., in another exemplified embodiment have a size of 144 square meters. Similarly, the size of the grid points may vary across different implementations of the invention. A small grid size may be provide a more accurate representation of a modified ground surface, however, this comes at the expense of requiring more time to compute and requiring larger data transfer and storage due to the increased data size of a digital modified ground surface representation with a higher resolution (or correspondingly smaller grid point size).

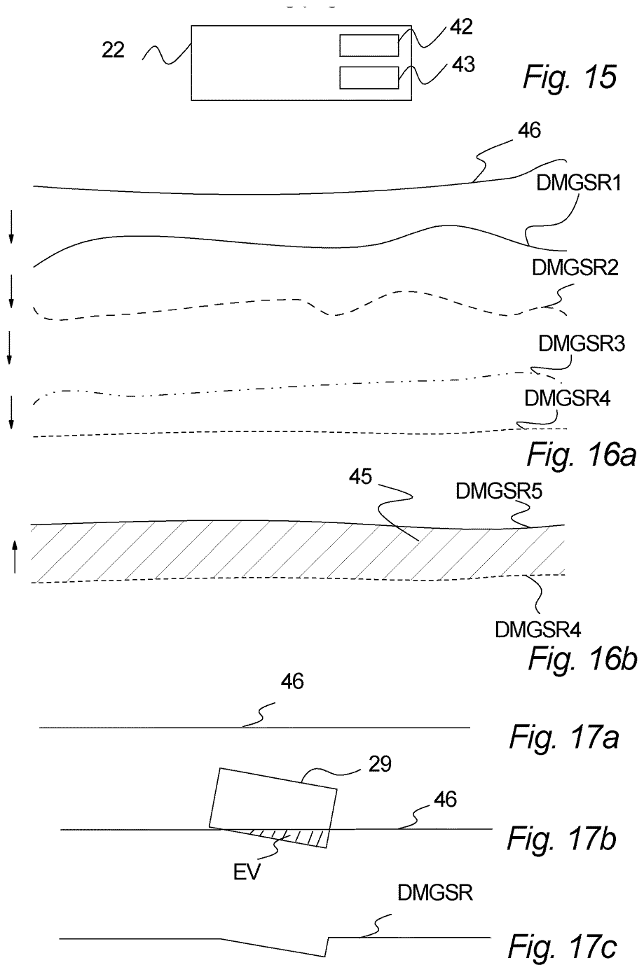

The digital modified ground surface representation may optionally be stored on a data server such as the data server illustrated in FIG. 15. However, the digital modified ground surface representation may also be stored on a ground modifier comprising a data storage. Such a ground modifier could, e.g., include any of the ground modifiers illustrated in FIG. 5, FIG. 6 and FIG. 7, if these ground modifiers where implemented with a data storage.

Each grid point may be indexed. The index may be unique to that grid point, such that only one grid point of a modified digital ground surface has that index. The digital modified ground surface representation may be updated during the modification of a terrain, as the modified ground surface changes, and the updated digital modified ground surface representation may be stored. Various types of storing may be utilized in different implementations of the invention. The storing may be performed by storing a digital modified surface representation. E.g. by an absolute storing of all grid tiles of the digital modified surface representation. Also, the storing may be performed per grid tile. Hence, grid tiles may be updated and stored individually. This may be advantageous, in that only grid tiles that has been changed are stored. Other grid tiles that has not change may thus not need to be stored. A time stamp indicating a time of storage may be registered to stored grid tiles.

Storing may, also, e.g., be performed based on differential logging, in which only the differences in the digital modified ground surface representation since the last storing/transmitting of a digital modified ground surface representation has been performed. This may, advantageously, reduce storage requirement and the amount of data transfer. Differential logging may optionally be performed per grid tile as described above in relation to the absolute storing.

In an embodiment of the invention, the digital modified ground surface representation may optionally be stored as a raster image (also referred to as a bitmap). E.g., it may, optionally, be stored as a png file or using other image formats and/or file formats. The raster image (sometimes referred to as raster data) may be considered a rectangular matrix of cells (grid points), which may, e.g., be represented in rows and columns. Each grid point (cell) may represent a defined area on the earth's surface and holds a value that is the same across the entire grid point. This may sometimes be referred to as a zero order approximation. Hence, a digital modified ground surface representation may be stored as a raster image, where each grid point in the raster image represents some value of real-world information, e.g. related to the digital modified ground surface representation. Each grid point may comprise various types of data, including e.g. elevation data. Optionally, various types of metadata may also be stored with the digital modified ground surface representation. Optionally, metadata relating to specific grid points may be stored together with other data relating to that grid point, such as e.g. ground material type, ground fill type, ground modifier ID, time stamp data, GNSS quality, color, number of passages of e.g. a ground modifier or a tool point, etc.

Optionally, the illustrated digital modified ground surface representation may be visualized in a multitude of ways including 2D and/or 3D representations on a display. E.g., including the exemplified display comprised of the ground modifier illustrated in FIG. 7 and the display illustrated in FIG. 8. In this context it should generally be noted that the displaying on the particular user interface, e.g. at tablet or a stationary interface located in or at the ground modifier, may facilitate that a user selects one or several possible rendering/presentation methods in order to fit the current desired purpose well. This is in particular relevant when the digital representation of what the ground modifier is doing to the terrain is (in particular when the model is updated on the basis of bottom of cut) updated in real-time. In that way it will be possible for the user of the ground modifier to be efficiently guided and assisted on a realtime basis. It should also be noted generally, that a visual representation may be performed at a given display on a given assumption that the user interface is related to a particular ground modifier. This coupling of identity may e.g. be done by a user of the user interface or it may be prestored in the user interface as a default, thereby automatically providing a relevant (to the particular ground modifier) displaying of the current digital modified ground surface representation at the user. In this way it is also possible to have at plurality of user interfaces, e.g. each being associated or facilitated to be associated to different ground modifiers and thereby allow all ground modifiers to work on the same digital modified ground surface representation and moreover allow the users of the ground modifiers to view different parts of the digital modified ground surface representation, the different parts being relevant for the users of the respective ground modifier. And this viewing may advantageously be updated in realtime to the degree it is possible.

Surfaces such as a ground surface and/or a modified ground surface and/or an updated modified ground surface may be digitally represented in various ways, according to the invention. In principle a surface of a terrain may comprise an infinite number of points, and since it may not be possible to represent a surface by an infinite number of samples, a digital representation of a surface of a terrain (also referred to as a digital ground surface representation and/or if the terrain has been modified, referred to as a modified digital ground surface representation) approximates the surface of the terrain based on surface samples representing the surface, e.g. the elevation of the surface, at different positions of the surface.

Optionally, the surface grid points may be interpolated to obtain the values between these sampled points. First order, second order, third order or higher approximations and/or other approximations may be applied according to various embodiments of the invention.

FIG. 4 illustrates an example of another grid tile than the four grid tiles illustrated in FIG. 3, comprising elevation data and further illustrates a three-dimensional representation of a grid point section of the grid tile according to an embodiment of the invention. The grid tile represents a grid tile of a digital modified ground surface representation.

The exemplified grid tile 28 now comprises a plurality (12×12=144) of grid points 27. In this exemplified embodiment of the invention, the grid points are indexed based on a set of two coordinates, which is illustrated with an x and a y. The coordinates indicate a position within the digital modified ground surface representation. This position further corresponds to a global position. Notice that the invention may be implemented using a different indexing.

The x coordinate indicates the column of the grid tile, while the y coordinate indicates the row of the grid. Furthermore, each grid point comprises a value. In this embodiment the value corresponds to elevation data, which indicates an elevation of a tool point position of a ground modifier. In this particular embodiment, the tool point position comprises the coordinates x and y, and the elevation value. Thus, the grid tile comprises grid points that all represent different tool point positions established during a modification of a ground surface of a terrain. The grid point section 29 comprises nine grid points comprising values between 1 and 4. As mentioned, the values represent an elevation of a tool point position, whereas their coordinates represent the other two dimensions of the tool point position. By visualizing the digital modified ground surface representation in three dimensions it may be possible to achieve a visual representation of a modified ground surface of a terrain. This may be realized by viewing the three dimensional grid point section representation 30 of the grid point section 29, which may be considered a subset of a digital modified ground surface representation. Please note that a tool point may both represent a singular point but also a geometry of a tool point of a relevant tool.

Optionally, a tool point position may be represented as geodetic coordinates.

Optionally, the digital modified ground surface is only updated when position information of a tool point comprises an elevation that is lower compared to an elevation at the corresponding position of the current digital modified ground surface representation. E.g., if the tool point at a global position, e.g. defined by coordinates x, y has an elevation of 4 and the corresponding elevation at that same global position in the digital modified ground surface representation is 7, then the digital modified ground surface representation is updated with the elevation of 4 of the tool point at that global position. On the contrary, as an example, the digital modified ground surface representation may not be updated if the elevation of the tool point in at the particular global position had an elevation larger than the elevation of the digital modified ground surface representation at the same global position. In this case, the digital modified ground surface representation may thus not be updated if the elevation of the tool point is 7 or more.

Optionally, the digital modified ground surface representation is only updated when the position information of a tool point at a global position comprises an elevation that is lower than an elevation at a corresponding global position of the digital ground surface representation.

FIG. 5 illustrates a schematical side view of a ground modifier with a positioning arrangement, according to an embodiment of the invention. The positioning arrangement comprises a local positioning arrangement and a global positioning arrangement.

The ground modifier comprises a wheelbase 2 carrying a body portion 3 to which a ground modification arrangement 4 is mounted. The ground modifier further comprises a tool point localizing module 13.

The wheelbase 2 of the ground modifier is configured to enable the ground modifier to move horizontally with respect to the surface of the terrain on which the ground modifier is positioned, e.g. a ground surface or a modified ground surface. The wheelbase may be configured in various ways and hence, the wheelbase may comprise a plurality of wheels and/or crawlers (tracks) with rollers and/or belts, etc., or combinations thereof.

In this embodiment, the body portion 3 of the ground modifier is a rotation body, which comprises a motor (not illustrated), a cab 5, and a global positioning arrangement 6. Thereby, the body may rotate at least 360 degrees with respect to the wheel base. The global positioning arrangement 6 is configured to provide global position information of the ground modifier. In this exemplified embodiment, the global positioning arrangement is a global navigation satellite system (GNSS) receiver. The global positioning information provided by the GNSS receiver provides information of the position of the ground modifier in relation to GNSS coordinates. In this embodiment, the global positioning arrangement 6 is positioned on the body portion 3, however, in other optional embodiments, it may be arranged differently and on other positions of the ground modifier.

The ground modification arrangement 4 is fixated to the body portion 3 of the ground modifier. The ground modification arrangement 4 comprises standard excavator components including a boom 7 moveably mounted to on the body portion 3, an arm 8 moveably fitted to the boom 7, and a bucket 9 moveably fitted to the arm via a linkage 10 and having a tool point 11, which in this embodiment corresponds to the tip of the bucket 9. The ground modification arrangement 4 further comprises a local positioning arrangement comprising local positioning sensors 12a-c. A local positioning sensors is also positioned on the rotational body portion of the ground modifier. The local positioning sensors (12a-d) are configured to obtain local positioning information of the position of the tool point 11. In this exemplified embodiment, the local positioning sensors are inertial measuring units (IMU). One IMU is provided for each degree of mobility (DOM) of the ground modifier. As such, one IMU is positioned on the boom 7, one IMU is positioned on the arm 8, one IMU is positioned on the linkage 10, and one IMU is positioned on the body portion. The IMU comprises a number of accelerometer and a number of gyroscopes. Each IMU thereby provides local position information computed from accelerometer data and gyroscopic data. Notice, that other local position arrangements may be utilized to provide local position information, depending on the implementation of the invention. An example of such other optional local position sensors comprises, e.g., joint angle encoders, which would be positioned to measure joint angles of the ground modification arrangement 4. The local positioning arrangement may also optionally utilize indirect measuring of joint angles (or joint motion). This could, e.g., be implemented by e.g. obtaining the displacement of the actuators that are configured to move parts of the ground modification arrangement, including e.g. the arm, the boom, the bucket etc. In the case of a hydraulic excavator, the displacement actuator could, e.g., be hydraulic cylinders comprising a rod which is displaced. The displacement of rods of hydraulic cylinders may thereby optionally be utilized to compute local positioning information in some optional implementations of the invention.

The abovementioned tool point localizing module 13 of the ground modifier is positioned on the body portion 3, in this exemplified embodiment. The tool point localizing module 13 is configured to determine the position of the tool point 10, based on local position information received from the local positioning arrangement and specifically from the local positioning sensors 12a-d, and based on global position information received from the global positioning arrangement 6. The tool point localizing module 13 may further be configured to log the determined tool point positions with a given sample frequency into a data storage (not illustrated), which in this exemplified embodiment is comprised of the tool point localizing module. When the ground modifier is applied to modify a terrain, the tool point essentially correlates with the cut made by the bucket into the terrain during the modification of the terrain. Thereby, the tool point localizing module 13 may establish a digital representation of the modified ground surface (a digital modified ground surface representation), based on the logged tool point positions obtained during the modification of the terrain with the ground modifier. Advantageously, the digital modified ground surface representation thus constitutes a surface map comprising information of where ground modifier has performed terrain modifications and to which depth.

Notice that the tool point position may be determined in various ways, depending on the implementation of the invention. The tool point position may, e.g., optionally be determined based on a kinematic model of the ground modifier, which in this exemplified embodiment is the ground modifier 1. The kinematic model may receive the local position information from the local positioning sensors 12a-d and may further comprise dimensional data of the particular ground modifier, e.g. the ground modifier. Dimensional data may, e.g., comprise length of parts of the ground modifier. E.g. distance between the joints connecting various parts of the ground modifier. E.g., the distance between the joint connecting the boom 7 with the arm 8 and the joint connecting the boom 8 with the body portion 3. Another example of dimensional data comprises the distance between the center point of the ground modifier and the attachment of the ground modification arrangement 4.

In this exemplified embodiment, the tool point localizing module 13 is communicatively connected to the global positioning arrangement 6 and to the local positioning sensors comprising the local positioning sensors 12a-d via wire (not illustrated). However, in other optional embodiments, the tool point localizing module 13 may be wirelessly connected to the global positioning arrangement 6 and to the local positioning sensors 12a-d.

In this exemplified embodiment, the digital modified ground surface is stored in a data storge (not illustrated) of the tool point localizing module 13. However, in other embodiments of the invention, the data storage may be located elsewhere, such as on an external device such as, e.g., a data server and/or on a computing device and/or on a data storge of another ground modifier.

In this exemplified embodiment, the digital modified ground surface representation comprises global coordinates, each associated with elevation data.

Optionally, the digital modified ground surface representation may comprise geodetic coordinates obtained on the basis of the local positioning data and the global positioning data.

Optionally, the digital ground surface representation may comprise metadata. Metadata may optionally include various data associated with each coordinate of the digital ground surface representation. Non-limiting examples of such data may comprise GNSS signal quality, time stamp data, color, ground compaction, etc.

In other optional embodiments, a further ground modifier may be e.g. applied together with an excavator, and such further ground modifier may e.g. be a bulldozer or a wheel loader. In the case of the wheel loader, the tool point 11 may represent, e.g., a point and/or a plurality of points where at a bucket of the wheel loader comes into contact with a ground surface so as to modify a ground surface. Furthermore, the ground modifier may optionally be a bulldozer, in which case, the tool point may, e.g., refer to a tool point of a blade of the bulldozer. In general, the tool point may optionally, e.g., be selected such that it defines a portion of the ground modification arrangement 4 that is directly in contact with the terrain during a modification of, e.g., a ground surface and/or a modified ground surface of the terrain. This could e.g. be the cutting edge of a bucket, a clamp shell bucket etc. The tool point may e.g. be defined in two dimensions, e.g. the cut width or a sub-portion of the cut width of e,g, a bucket or a clamp shell bucket. The tool point may also be defined in three dimensions. Also the shape of a tool point may be represented. E.g. a cutting edge of a bucket may have a curved shape, which may be represented by the tool point. Notice that another example of a ground modifier is a wheel loader. Hence, the tool point may be understood as a representation of a ground modifying tool, the cutting edge of the ground modifying tool, e.g. a bucket of an excavator. A tool point position may thereby further be understood as a position of the full representation of the tool point. E.g. a full representation could e.g. be a representation of the cutting blade of a bucket of a ground modifier, including e.g. an excavator. The tool point positioning could be represented in various ways within the scope of the invention.

Optionally, the tool positioning module may be comprised of a data server. The data server may optionally be positioned externally with respect to the ground modifier. In this optional implementation of the invention, the data server would be configured to receive global positioning data and local positioning data from one or more ground modifiers, and the one or more ground modifiers would be configured to transmit the global position information and the local positioning information, e.g., via an onboard transmitter. Optionally, the one or more ground modifiers may comprise a receiver configured to receive digital modified ground surface representation from the data server.

Optionally, the ground modification arrangement 4 may be arranged differently in other embodiments, e.g., be mounted on the wheelbase instead of on the body portion.

Optionally, the ground modifier may comprise two or more of the global positioning unit 6. Advantageously, this provides the possibility of determining the center point of the ground modifier. The center point may advantageously be utilized as the global position of the ground modifier and thereby the position of the tool point may be determined relative to this center point.

Optionally, the global positioning arrangement may comprise and/or be based on total stations, radio triangulation, computer vision etc.

Optionally, the illustrated ground modifier may be an excavator.

FIG. 6 illustrates a top view of an excavator 100 according to an embodiment of the invention. The excavator is an exemplified embodiment of a ground modifier. The excavator 100 comprises a wheelbase 2, a ground modification arrangement 4 moveably fixated to a body portion 3, which is moveably fixated to the wheelbase 2.

The body portion comprises two global navigation satellite system (GNSS) receivers 18a-b and a tool point localizing module 13. The GNSS receivers receives global position information to the tool point localizing module 13 via wire.

The ground modification arrangement 4 comprises an inertial measuring unit (IMU) 24a positioned on the boom 7, an IMU positioned on the arm 8 and a IMU positioned on the linkage 10. A further IMU is positioned on the body portion (not illustrated). Based on each IMU, local position information is computed based on accelerometer and gyroscopic measurements. The local positioning information is communicated to the tool point localizing module 13 via wired connection. In this embodiment, the tool point 11 is selected as the center point on the tip of the bucket 9. The accelerometer and gyroscopic data may in other embodiment of the invention be received by the tool point localization module, which may then compute local positioning information based on the received data.

The tool point localizing module 13 is configured to determine a tool point position of the tool point 11, based on the local position information received from the IMUs 24a-c and the global positioning information received form the GNSS receivers. The combination of the local position information and the global position information is referred to as positioning information.

In this example, the tool point 11 is the width of the cutting edge of the bucket 9 as illustrated by the stipulated line with arrows in FIG. 6. In this exemplified embodiment, the tool point position thereby represents the width of the cutting edge of the bucket 9. When a digital modified ground surface representation is established based the tool point 11 in this exemplified embodiment, the digital modified surface representation may thus represent the width of the tool point 11, and the shape of the tool point 11.

### EXAMPLE 1

In this example, the excavator 100 is applied to modify a terrain such as the terrain 14 illustrated in FIG. 2a. Specifically, the excavator 100 is applied to remove the vegetation 17 from the ground surface 15. The excavator 100 is operated by an operator, which is a person. However, optionally, an automatic excavator that does not need an operator could be utilized according to the invention.

When the excavator 100 starts moving towards the vegetation 17, the position of the excavator 100 is obtained by the GNSS receivers, which tracks the position of the excavator 100. When the excavator has reached the vegetation, the operator starts moving the tool point to begin modifying the terrain 14, e.g. by removing the vegetation 17, by using the ground modification arrangement 4. During this motion, the IMUs 24a-c provides local position information related to the tool center point 11. Both the local position information and the global position information is fed to the tool positioning module 13, which determines a tool point position. Since this embodiment comprises two GNSS receivers, it is possible to determine an areal center of the excavator 100. This enables the tool point localizing module to utilize this areal center point of the excavator as a reference point for the position of the tool point 11, and thereby utilizing the local positioning information received from the IMUs 24a-c, the tool point position module 13 determines the tool point position. The tool point position is repeatedly determined and updated during the terrain modification, and thereby the tool point localizing module utilize the determined tool point positions to establish a digital modified ground surface representation.

The continuously updated digital modified ground surface representation may then be continuously displayed on a user interface associated with a ground modifier in a form and with reference to location(s) relevant to the user of the ground modifier. This displaying may also be referred to as a real-time tracking of the resulting work of a ground modifier, which may be displayed also in realtime on a display related to one or more relevant ground modifiers operating the terrain reflected by the digital modified ground surface

In this example the digital modified ground surface representation is repeatedly updated during the terrain modification based on the tool point positions. When the terrain modification has been completed, the modified terrain 14 now comprises a modified ground surface 17 as illustrated in FIG. 2b, which comprises no vegetation.

During modification of the terrain, the established digital modified ground surface representations including the updates to the digital modified ground surface representations have been automatically stored on a data storage. In this exemplified embodiment, the data storage is comprised of the ground modifier. Optionally, the data storage may be located on an external data server.

Optionally, the tool point positioning is determined based on a kinematic model associated with the excavator 1. The kinematic model utilized the global position information and the local position information to determine the tool point position. Optionally, the kinematic model may be comprised of the tool positioning module.

Optionally, a digital representation of the ground surface may be established, e.g., based on a drone surface scan.

FIG. 7 illustrates a schematical side view of a ground modifier, which in this exemplified embodiment is an excavator 100, comprising a tiltrotator and a user interface 19. The ground modifier may be implemented to perform the method illustrated in FIG. 1.

The illustrated excavator is similar to the excavator illustrated in, e.g., FIG. 6. However, this exemplified embodiment of an excavator 100 comprises a tiltrotator 25 with an additional local positioning sensor 12d position on the tiltrotator, and a user interface 19. The user interface comprises a display and the user interface 19 is positioned in the cab 5 so as to enable an operator of the excavator 100 to view the display. The display is configured to display a visual rendering of one or more digital modified surface representations. FIG. 10 comprises examples of a rendering of a digital modified surface representations. However, the digital modified ground surface representations may be rendered in a multitude of ways according to different implementations of the invention.

The tiltrotator 25 adds an additional degree of mobility to the excavator. In particular the tiltrotator 25 enables the excavator to rotate the bucket 9, and thereby the excavator is highly flexible with regards to ways it may modify a terrain. The additional local positioning sensor 12d is configured to provide local positioning data of the motion provided by the tiltrotator, while an additional local positioning sensor positioned on the body portion of the excavator (not illustrated) provides local positioning data of the rotational motion of the body portion with respect to the wheelbase. The other local positioning sensors 12a, 12b 12c, provide local position information related to the other moving parts of excavator, similar to the excavator and ground modifiers illustrated in FIG. 5 and FIG. 6, respectively.

The excavator 100 further comprises two global positioning arrangements 6a,6b and a tool point localizing module 13. The tool point localizing module 13 is configured to establish a digital modified surface representation based on the local positioning information and said global positioning information. The tool point localizing module 13 is connected to said user interface 19, which comprises a display. In this embodiment the connection is wired. The display is configured for displaying the digital modified ground surface representation established by the tool point localizing module transferred to the display via the wired connection.

When the excavator 100 is utilized for modifying terrain, the digital modified ground surface representation is updated repeatedly over time to reflect the modified ground surface. By repeatedly transmitting the digital modified ground surface representation form the tool point localizing module 13 to the display of the user interface 19, the operator of the excavator may follow the terrain modifications that have been performed.

Optionally, the user interface may be configured to enable an operator (user) to select a ground material type of a modified ground surface. The user interface may provide options of ground material types, which may be selected. When a ground material type has been selected, the ground material type may be associated with the corresponding digital modified surface representation established by the tool point localizing module.

Optionally, the selected ground material type may be stored together with the corresponding digital modified ground surface representation. E.g., the ground material type may be stored as metadata to the digital modified ground surface representation. This may optionally, e.g., be carried out by embedding the metadata into the digital modified ground surface representation.

Optionally, the user interface may display the ground material type.

Optionally, the connection between the tool point localizing module 13 and the user interface 19 may be wireless.

FIG. 8 illustrates a terrain modification logging system according to an embodiment of the invention. The terrain modification system may advantageously be implemented on a ground modifier, such as on e.g. an excavator, and thereby the system may facilitate the method illustrated in FIG. 1 to be carried out.

The terrain modification logging system 31 comprises a tool point localizing module 13, local positioning sensors 12a-12n, global navigation satellite system (GNSS) receivers 18a-18n and a user interface 19 comprising a display 23. Furthermore, the tool point localizing module 13 comprises a tool point positioning determiner 20, a surface determination module 21 and a data server 22.

The tool point localizing module 13 is connected to the local positioning sensors 12a-12n and to the GNSS receivers 18a-18n. Thereby, the tool point localizing module 13 receives local positioning information from the local positioning sensors 12a-12c and global positioning information from the GNSS receivers 18a-18b. The stipulated drawing of the GNSS receiver 18n and the stipulated local position sensor 12n indicates that the system may be expanded with additional local positioning sensors and global positioning sensors. This may be advantageous, if the system should be implemented on a ground modifier having a ground modification arrangement with more than three degrees of freedom of movement, e.g., such as a multi boom excavator.

Based on the received local positioning information and global positioning information, the tool point position determiner 13 is capable of determining tool point positions when the tool point of a ground modifier is moving during a modification of a terrain. The tool point position is received by the surface determination module 21, which then establishes a digital modified ground surface representation based on the tool point positions received from the tool point position determiner 20. The digital modified ground surface representation is send to the data server 22, which stores the digital modified ground surface. The digital modified ground surface is further send to the display 23 of the user interface 19. In this embodiment of the invention, the user interface is a computing device comprising the display 23. The computing device could be a table, a personal computer, a smart phone device or other computing devices comprising a display.

Optionally, but advantageously, the surface determination module may compare an elevation of a currently determined tool point position with an elevation of a corresponding previously determined tool point position. Then if the elevation of the current tool point is lower compared to the previously determined tool point position, the surface determination module updates the digital modified ground surface representation with the current tool point position. Hence, optionally, the tool point localizing module 13 comprising the surface determination module may perform a step of updating a digital modified surface representation when a tool point position of one or more ground modifiers has a lower elevation compared to an elevation of a corresponding tool point of a previous digital modified ground surface representation. Optionally, the step is not performed when the elevation of the current tool point position is larger compared to the elevation of a previously determined tool point position at the same location. E.g. at the same global position.

The actual and measured tool point position of the physical tool will therefore be used for modification of the digital representation of how the physical ground surface is, or is at least expected to be. This digital measure is thus used for a running updating, i.e. modifying, of the digital modified ground surface representation. By obtaining the tool point position during movement of the tool point, the trajectory of the tool may be tracked. Hence, advantageously, the digital modified ground surface representation may be based on this tacked trajectory of the tool point.

In this way, the lowest position of the tool point of a ground modifier, e.g. an excavator, is applied for on a run time basis keeping the digital modified ground surface representation updated during physical processing of a corresponding physical ground surface.

It should be noted that the updating of the digital modified ground surface representation representing a corresponding physical ground surface may be performed with “input” from 2, 3, 4 or several ground modifiers as long as these ground modifiers, and the data measured in relation to movement of the ground modifiers respective tool points at some point of time is transmitted to the system and used as a basis for updating the “shared” workspace, i.e. the digital modified ground surface. Each update of the digital modified ground surface may typically be geodetic data, e.g. include location coordinates and associated elevation.

Each update of the digital modified ground surface representation may be stored with associated meta data such as time, indicating the time (e.g. including minute, hour, date and year at which the respective digital modified ground surface representation was made. A further example of metadata may include GNSS signal quality.

The use of time stamps related to how a digital ground surface representation “looks” at a certain point of time will make it possible to go back in time to document when a certain part of the processing of the ground has been performed. In other words, it may be possible to visualize or somehow illustrate to a user of the system how a ground surface is at a given time.

Other meta data may e.g. also include type of ground surface excavated, etc. Optionally, the type of ground surface excavated is stored as meta data for each digital modified ground surface representation. Advantageously, a digital modified ground surface may then be labeled according to the ground material type. By storing the labeled digital modified ground surface representations, layers of digital modified ground surface representations may be established. These layers may thus advantageously, represent different layers of actual ground material. Advantageously, this may enable a log of the different layers that has been excavated based on the labeled digital modified ground surface representations, which is advantageous. The labeling may optionally be performed manually by selecting a ground material type on a user interface. E.g. a user interface of a ground modifier. The ground material type may be predetermined. However, the operator of the ground modifier may optionally specify a new ground material type. This may be advantageous when a ground material type being excavate is not included among the predefined options.

Further, the data server may optionally perform a step of automatically storing a digital modified surface representation only when a tool point position of one or more ground modifiers has a lower elevation compared to an elevation of a corresponding tool point of a previous digital modified ground surface representation.

In further optional embodiments of the invention, the terrain modification logging system may be implemented without the user interface 19 comprising the screen 23 ground modification computing device.

Optionally, the user interface enables an operator of the terrain modification logging system to turn via the user interface 19 a displaying of digital modified ground surface representation on the screen 23 of the user interface 19. Optionally, when the user choose to turn of the displaying of digital modified ground surface representation, established digital modified ground surfaces may still be stored on the data server.

Optionally, the terrain modification system may be retrofitted to a ground modifier such as, e.g., an excavator. This may advantageously enable the ground modifier to perform the method of the invention illustrated in FIG. 1.

Optionally, the terrain modification logging system may be configured to enable a user to select a ground material type of a modified ground surface. Advantageously, when selecting the selected ground material type, the ground material type is associated with a corresponding digital modified surface representation of the modified ground surface as associated metadata. The metadata may optionally be stored with the corresponding digital modified ground surface representation. E.g., the metadata may optionally be embedded in the digital modified ground surface representation.

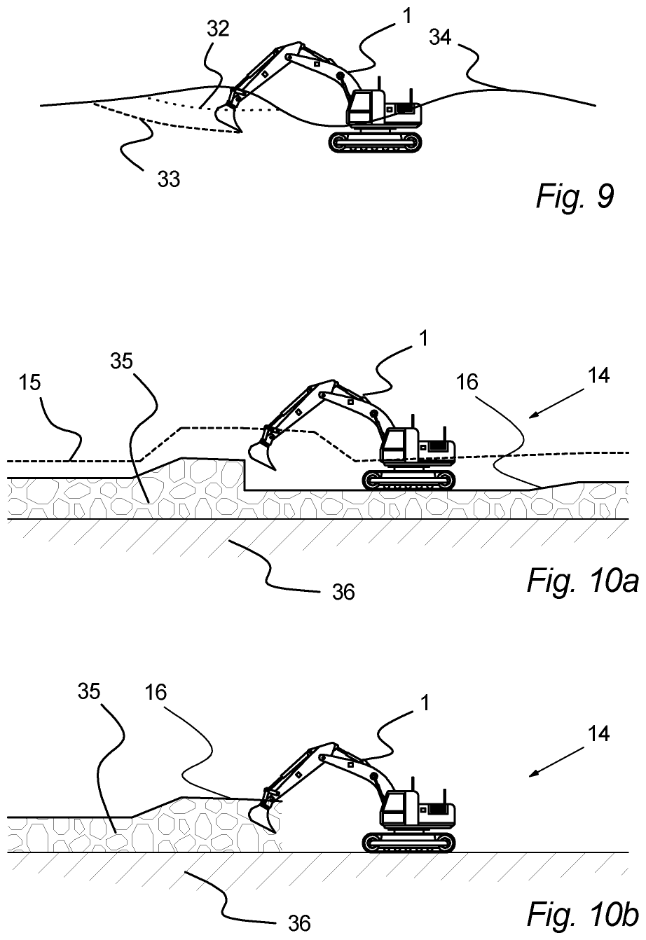

FIG. 9 illustrates a schematical representation of a visualization of digital modified ground surface representations and a ground surface representation.

FIG. 9 illustrates a ground modifier 1 alongside a visual rendering of a digital ground surface representation 34, a previous digital modified ground surface representation 32 and a current digital modified ground surface representation 33.

The digital ground surface representation 34 represents a real world terrain that has not yet been modified. The visualized previous digital modified ground surface representation 32 represents a previous modified ground surface that has been modified. In this example the previous modified ground surface has been modified by the ground modifier 1. The previous modified ground surface representation 32 represents tool point positions established during the modification of the previous modified ground surface.

The visualized current digital modified ground surface representation represents a current modified ground surface that is currently being modified. The visualized current digital modified ground surface representation is established based on tool point positions that is repeatedly established as the ground modifier 1 modifies a terrain. Hence, physical three dimensional modification to a terrain carried out with a ground modifier may be represented with a corresponding three dimensional change in a digital modified ground surface representation. In other words, when a well-defined volume is carved from a real world terrain using a ground modifier, a corresponding digital modified surface representation is carved correspondingly to establish an updated digital modified ground surface representation. Advantageously, the carve of terrain may thereby be visually rendered by the update of the digital modified ground surface representation of the carve. In other words, the digital modified ground surface representation is updated such that it tracks the movement that occur during the modification of the terrain, and such that it creates a visual trajectory when visualized on a display.

Optionally, the current digital modified ground surface representation represents the deepest tool point positions of a tool point of the ground modifier 1. This deepest tool point positions may hence represent the bottom of cut. Optionally the current digital modified ground surface representation is updated only when the elevation of a tool point position of a current digital modified ground surface representation is lower than an elevation of a previous digital modified ground surface representation at a corresponding position. Thereby, the most recently established digital modified ground surface representation may represent the latest modification made to a terrain to establish a modified terrain. E.g. a modification made by removing ground material from a terrain, e.g., by digging etc. It should be understood that a digital modified ground surface representation may be visually rendered in a variety of ways within the scope of the invention. This includes, e.g. three dimensional rendering, two dimensional rendering etc. The digital modified ground surface representations and the visual rendering thereof may be updated such that when viewed on e.g. a display, it creates a visual perception of real-time tracking of the actual physical motion of a tool point moving to modify a terrain.

FIG. 10a and FIG. 10b illustrate terrain comprising different ground material types. The ground materials may optionally be labeled according to ground material type, either manually by an operator or automatically.

In FIG. 10a terrain 14 comprises a ground surface 15, which have been modified into a modified ground surface 16 using ground modifier 1. The ground surface comprises the ground material type clay 5 and further down the ground surface material sand 36.

In FIG. 10b, the ground surface 15 has been further modified into the modified ground surface 16. During this further modification, an operator selects the ground type material, which is clay, on a user interface of the ground modifier, since the modified ground surface comprises clay. The ground material type clay is thereby stored together with a digital modified ground surface representation of the modified ground surface. The ground type material is stored as type of metadata. The ground material type thereby may define labeled digital modified ground surface representations, which thereby represents layers of ground material. E.g. a layer of rock, a layer of soil, a layer of sand etc.

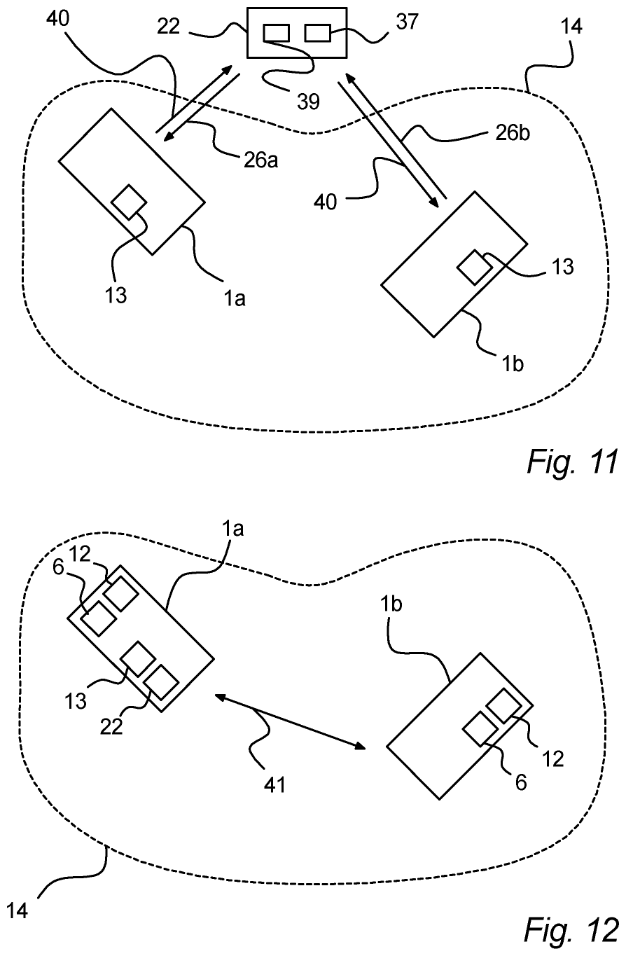

FIG. 11 illustrates a schematical top view of a terrain comprising two ground modifiers communicating with a data server.

In this example, the terrain 14 is a terrain of a construction site. Each of the two ground modifiers 1a,1b are working with modifying a terrain comprising a ground surface (not illustrated). Both ground modifiers 1a,1b comprises a terrain modification logging system at least comprising a tool point localizing module 13. An example of a terrain modification logging system is illustrated in FIG. 8. However, different to the system illustrated in FIG. 8, the tool point localizing module 1a and 1b does not comprise a data server. Instead, the data server 22 is provided as an external data server comprising a surface combinator module 39. The data server 22 is thereby configured to communicate with a plurality of ground modifiers such as the ground modifiers 1a and 1b, and to combine received digital modified ground surface representations. During the process of modifying the terrain 14, the ground modifiers 1a and 1b both obtain positioning data, which is utilized by the tool point localizing module 13 to establish digital modified ground surface representations 26a and 26b, respectively. Digital modified ground surface representations 26a, 26b and updates thereof established during the terrain modification, is transmitted from each of the ground modifiers 1a, 1b to the data server via a transmitter (not illustrated) comprised of each ground modifier 1a, 1b. The data server receives the digital modified ground surface representation 26a,26b established with both of the two ground modifiers 1a, 1b and the surface combinator module 39 combines the received digital modified ground surface representations into a combined digital modified ground surface representation 40, which comprises both of the two received digital modified ground surface representations 26a,26b. In this exemplified embodiment, both the two received digital modified ground surface representations 26a, 26b are stored in the data log 37 comprised of the data server 22. The combined digital modified ground surface representation 40 is transmitted to each of the ground modifiers 1a,1b. In this example, the ground modifiers 1a and 1b comprises a user interface comprising a display, which enables each of the ground modifiers to view visual renderings of combined digital modified ground surface representations 40 received from the data server 22. Advantageously, operators of the ground modifiers 1a,1b is thereby provided an overview of the terrain modifications that have been carried out based on any of the ground modifiers working on the terrain 14, which could be e.g. working on at the same construction site.

Optionally, combined digital modified ground surface representations may be stored in the data log 37 of the data server 22.

Optionally, the data server 22 may not comprise a surface combinator module. In this optional embodiment, the data server may still store received digital modified ground surface representations in the data log. The data server may communicate with a plurality of ground modifiers and may thereby receive and store in the data log digital modified ground surface representations from many ground modifiers.

The data server 22 may optionally receive digital modified ground surface representations form ground modifiers working at different terrains, e.g. working at different construction sites.

Optionally, the data server may be a cloud server.

Optionally, stored digital modified surface representations may be retrieved via a user interface that is not implemented in a ground modifier. The user interface cold comprise a tablet, a personal computer or another computing device comprising a screen.

FIG. 12 illustrates a schematical top view of a terrain comprising two communicating ground modifiers.

In this exemplified embodiment of the invention, both of the two ground modifiers comprises local positioning sensors 12 and global positioning arrangement 6. In addition, the first ground modifier 1a further comprises a tool point localizing module 13 and a data server 22. Thereby the first ground modifier 1a is capable of establishing digital modified ground surface representations. The ground modifiers 1a, 1b communicate via a data communication link 41. In this embodiment, the data communication link is a wireless connection. Via the data communication link, the second ground modifier 1b transmits positioning data comprising local position information and global positioning information to the first ground modifier 1a. The tool point localizing module 13 repeatedly receives the positioning data from second ground modifier 1b and utilize the positioning data to repeatedly establish digital modified ground surface representation associated with the second ground modifier, which is automatically stored in a data log (not illustrated) on the data server 22.

The tool point localizing module 13 further establishes and stores on the data server 22 digital modified surface representations for the first ground modifier 1a, based on position information received from the local positioning sensors 12 and the global positioning arrangement 6 of the first ground modifier 1a.

Optionally, the digital modified ground surface representation established based on positioning information data from the second ground modifier 1b using the tool positioning module 13 of the first ground modifier may be transmitted to the second ground modifier 1b. The second ground modifier may thus optionally view a rendering of the received digital modified ground surface representation on a display of a user interface of the second ground modifier.

Optionally, one or more of the ground modifiers may comprise a surface combinator module configured to generate combined digital modified ground surface representations based on digital modified ground surface representations from each of the ground modifiers. Optionally, the first ground modifier comprises a surface combinator module and transmits combined digital modified ground surface representations to the second ground modifier 1b.

It should be understood that data communication link may refer to any form of connection used for data communication. This may include the following non-limiting examples: cellular communication, satellite based communication, Wi-Fi, Bluetooth etc.

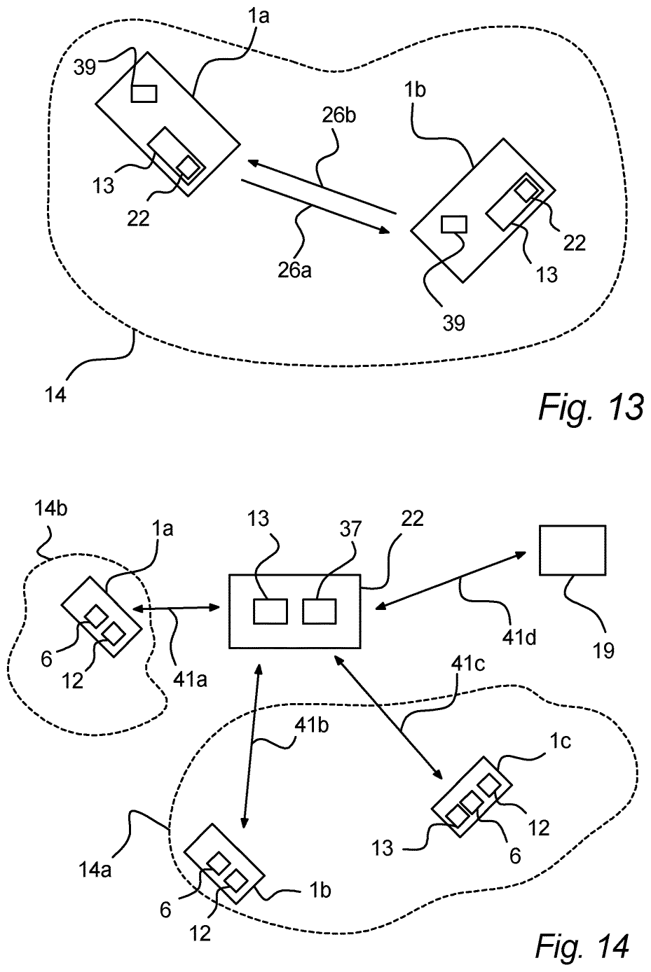

FIG. 13 illustrates two communicating ground modifiers each comprising a tool point localizing module and a data server.

In this exemplified embodiment of the invention, two ground modifiers comprising a tool point localizing module 13, a data server 22 and a surface combinator module 39 is communicating digital modified surface representations wirelessly with each other. Based on the surface combinator module 39, each ground modifier is able to combine digital modified ground surface representations representing the ground modifiers own modification of terrain, with a digital modified surface representation a digital modified ground surface representations received form the other ground modifier. Each ground modifier is further able to establish a local data log on the data server 22 comprising digital modified ground surface representations.

Optionally, combined digital modified ground surface representations may be stored in the data log on the individual data servers 22.

Optionally, the local data log may be shared with a cloud server (not illustrated). The cloud server may optionally communicate and exchange data with ground modifiers working on different terrains.

FIG. 14 illustrates communication between a data server and a plurality of ground modifiers working at two different terrains.

In this exemplified embodiment of the invention, a first ground modifier 1a is modifying a first terrain 14b. The ground modifier 1a comprises global positioning arrangement 6 and local positioning sensors 12 from which position information is obtained. The position information is transmitted via data communication link 41a to a data server 22 comprising a tool point localizing module 13 and a data log 37. The data server 22 may therefore establish a digital modified ground surface representation based on the positioning data received from the first ground modifier 1a, and further, automatically store the digital modified ground surface representation. This may be performed repeatedly, as new positioning data is received by the data server 22. The data server 22 may optionally transmit digital modified ground surface representations of the first ground modifier via the communication link 41a to the first ground modifier.

A second ground modifier 1b and a third ground modifier 1c is working with modifying a second terrain 14a. Similar to the first ground modifier, the second ground modifier does not comprise a tool point localizing module, and thereby this ground modifier utilizes the data server 22 to establish and store digital modified ground surface modifications based on positioning information transmitted via the data communication link 41b. The third ground modifier 1c comprises a tool point localizing module 13, and thereby is able to establish digital ground surface representations independently of the data server 22. Hence, the third ground modifier 1c may transmit digital modified ground surface representations via the data communication link 41c to the data server 22, where the digital modified ground surface representation and further updates thereof is stored.

Optionally, the data server 22 may comprise a surface combinator module and thereby digital modified ground surface representations may be combined to establish combined digital modified ground surface representations. The combined digital modified ground surface representations may be transmitted via the data communications links to ground modifiers. This may typically be advantageous for ground modifier working to modify the same terrain, e.g., in this example, the second and the thirds ground modifiers 1b,1c.

By providing a central storage by means of the data server 22, it is possible to retrieve data stored on the data server 22 via data communications links 41. In this exemplified embodiment a user interface 19 establish connection to the data server 22 via the data communication link 41d, to retrieve digital modified ground surface representations and/or combined digital modified ground surface representations. This may, e.g., be advantageous for, e.g., a construction manager who needs an overview of terrain modification. Further advantageously, the stored digital modified ground surface representations may advantageously be retrieved and utilized to document the performed terrain modification. E.g., it may be documented that ground material has been removed from a certain position and to a certain depth that was required. E.g., required to ensure certain construction safety standards etc.

Optionally. the second ground modifier may utilize the tool point localizing module comprised of the third ground modifier 1c to establish digital modified ground surface representations as described in relation to FIG. 12.

FIG. 15 illustrates an exemplified embodiment of a data server 22 which may be applied in any of the previous embodiments.

The data server 22 comprises a processor 42 and a memory 43. The data server may be utilized to automatically store digital modified ground surface representations, including combined digital modified surface representations.

Optionally, the data server may be implemented as a distributed data system, such as a cloud computing server, comprising multiple storage nodes. This may be advantageous in large systems comprising a multitude of ground modifiers working across various sites across the globe.

FIG. 16a and FIG. 16b illustrates digital modified ground surface representations established over time according to an embodiment of the invention. The digital modified ground surface representations illustrated in FIG. 16a DMGSR1-4 is established as a result of a downward excavation of a terrain as illustrated by the downward pointing arrows. A digital ground surface representation (46) is also illustrated.

The digital modified ground surface representation DMGSR5 is a result of filling of ground surface material.

A first digital modified ground surface representation DMGSR1 is established at a time T1, based on a downward excavation with a ground modifier.

At time T2 a second digital modified ground surface representation DMGSR2 illustrates a further downward excavation where further ground material has been removed from the terrain, using the ground modifier.

At a later time T3, a third digital modified ground surface representation DMGSR3 is established based on further excavation with the ground modifier.

At an even later time T4, a fourth digital modified ground surface representation DMGSR4 is established based on an additional excavation being performed by the ground modifier. The fourth digital modified ground surface representation may be considered an update of the former mentioned digital modified ground surface representations (DMGSR1-DMGSR3).

After having excavated ground material to reach a depth represented by the digital modified ground surface representation DSMR4, a ground modifier may fill ground fill material 45 on the excavated terrain with the depth (or elevation) represented by the digital modified ground surface representation DMGSR4.

As the ground modifier moves the terrain to fill the terrain with ground fill material, the position of the wheelbase of the ground modifier may be tracked to provide positioning information. The positioning information is utilized for establishing a further digital modified ground surface representation.

In this exemplified embodiment of the invention, the ground fill material is sand. However the ground fill material could be any ground fill material, such as rock, gravel, dirt etc.

The above illustrated digital modified ground surface representations are illustrated as 2D, i.e. as cross-sections.

Alternatively, the digital modified ground surface representation may also be shown and rendered as 3D illustrations.

Such illustrations may in an application advantageously be rendered on one or more associated displays, i.e. of a user interface.

The above illustrated digital modified ground surface representations may also be regarded as layers in a representation, where the layers each represent a corresponding entity, such as landfill type, ground surface type, ground material type, etc.

Each layer visualized above at some time represented a corresponding current state of the physical world, e.g. a progress at a given time. These layers may be visualized to the extend the user wishes and/or to the extent the user interface facilitates such a displaying. In between the layers are established, the user interface may advantageously on a run-time basis display the progress of the progress. In other words, the user may on a run-time basis follow the physical work-process, when e.g. an excavator digs through a layer. The updating, may be performed as often as required, e.g. a visual update on the display of the measured digital ground surface representation.

Furthermore, models may be overlaid on the user interface, on and off, to assist the user (of the ground modifier) to reach and establish what needs to be done, but most importantly, the user may track the progress of the real work in the digital 2D or 3D domain. A user may also choose to display a work-progress according to certain specified available metadata, such as time, date, landfill type, etc.

More, it may also be possible to document whether a project plan has been complied with by re-calling the desired relevant digital modified ground surface representation, thereby revisiting what has been done, and e.g. also by ground modifier.

Optionally, positioning information of the wheelbase of the ground modifier may overrule a tool point position, and thereby positioning information of the wheelbase may be utilized for identifying a ground fill, where the elevation is increased as opposed to decreased.

Optionally, a digital modified ground surface established based on a tool point position may be updated based on positioning information of a wheelbase of a ground modifier.

Optionally, the digital modified ground surface representations may be visualized, e.g. on a display, e.g., of a ground modifier.

Optionally, the digital modified ground surface representation may only be visualized when the digital modified ground surface representation is below an original ground level. Optionally, the original ground level may be represented as a digital ground surface representations.

Optionally, the digital modified ground surface representation may only be stored when the digital modified ground surface representation is below an original ground level (OGL). Optionally, the original ground level may be represented as a digital ground surface representations.

Optionally, the digital ground surface representations may be based on a laser drone scan.

Optionally, the digital ground surface representations may be applied as a filter, in the sense that only the digital modified ground surface representations having an elevation below the digital ground surface representation may be visualized and/or stored. Optionally, automatic storing of digital modified ground surface representations may be performed even in situations where visualization of the digital modified ground surface representations is turned off via a user interface by an operator of the ground modifier.

FIG. 17-a-c illustrate different stages of a modification of a terrain and how a corresponding digital representation may be modified to correspond to the actually expected performed terrain modification.

The below FIGS. 17a-c are of course simplified but they are focused on giving an understanding of how modifications of an advantageous digital modified ground surface representation may be obtained in a relatively simple way, but also to represent validly (still an estimation, though) the actually performed earth work.

FIG. 17a shows a cross-section/side view of a digital ground surface representation 46. This digital ground surface representation 46 may of course be the result of earlier previously performed earth works and be represented by correspondingly established digital ground surface representations.

It should be noted that the illustrated view may be illustrated on a user inface such as a display in several other ways as the digital ground surface representation is continuously modified in a 3D domain in order to represent the actual terrain modification-which in real-life is 3D.

The digital ground surface representation 46 may thus of course also be visualized in different types of 2D and 3D representations, seen from different perspectives depending on what is available to a user of a user interface presenting the digital ground surface representation 46 or parts of it relevant for a user. The user interface should advantageously be available for a user of a ground modifier to facilitate the user following the progress of the earth work in real-time by looking at a visualization on a respective user interface visualizing current, past or planned digital ground surface representations at the particular/relevant geographical location.

In FIG. 17b a bucket 29 of a respective ground modifier (not shown) is shown from the from. In embodiments of the invention and explained elsewhere in the present application a digital ground surface representation is continuously modified to represent what has actually been done to the terrain by one or more ground modifiers. In an advantageous embodiment this is performed un a real-time basis by updating the digital ground surface representation to reflect a bottom off cut, i.e. the lowest measured point relevant tool points, e.g. a blade of bucket, has been positioned at a given position and preferably also at a given time.

The accumulation of all these measured positions should preferably reflect how the actual modified terrain looks as close as possible. In order to do this as close as possible, the lowest part of an applied and measured tool point may be obtained by including a 2D or 3D geometry of the actually applied tool point as already explained above. As primitively illustrated in FIG. 17b a bucket 29 is illustrated as seen from the front and both the geometry of the bucket itself is applied but also the actually position relative to the terrain and the respective digital ground surface representation 46. It is here primitively illustrated that a 2D representation of the bucket 29 is tilted with respect to the terrain and the respective digital ground surface representation 46 and thereby resulting in a corresponding to an estimated modification of the real-life terrain given by the relative geometry of the bucket, i.e. the combination of the geometry of the tool point, here the bucket, and how the bucket is moved relative to the ground surface. In FIG. 17b the geometry of the tool point the relative movement of the tool point of the tilted bucket 29 results in a corresponding modification of the terrain, here illustrated as an excavated volume EV. In other words, the dimensions of the tool applied (in particular of what is regarded the tool point), and the measured relative position to the ground surface may advantageously be applied as a basis for the run-time updating of a corresponding digital model, which is here shown in FIG. 17c as a digital modified ground surface representation.

Generally, a tool point when referred to in relation to modification of a terrain and the establishment of respective updated digital ground surface representations, may thus advantageously be referred to as the geometry of an applied tool and its respective tool point (e.g. a blade of a bucket) to the terrain/digital ground surface representation which is about to be modified and updated correspondingly in the digital model at a given (automatically measured) geographical position.

As mentioned above, an edge of a bucket (or other tool point) may have a curved shape, which may be referred to as a tool point. Notice that another example of a ground modifier is a wheel loader. Hence, the tool point may be understood as a representation of a ground modifying tool, the cutting edge of the ground modifying tool, e.g. a bucket of an excavator. A tool point position may thereby further be understood as a position of the full representation of the tool point. A full representation could e.g. be a representation of the cutting blade of a bucket of a ground modifier (e.g. an excavator). The tool point positioning could be represented in various ways within the scope of the invention e.g. in various 2D and 3D representations.

### LIST OF REFERENCE SIGNS

1a-b Ground modifier
2 Wheelbase
3 Body portion
4 Ground modification arrangement
5 Cab
6a-b Global positioning arrangement
7 Boom
8 Arm
9 Bucket
10 Linkage
11 Tool point
12a-n Local positioning sensor
13 Tool point localizing module
14a-b Terrain
15 Ground surface
16 Modified ground surface
17 Vegetation
18 Global navigation satellite system (GNSS) receiver
19 User interface
20 Tool point position determiner
21 Surface determination module
22 Data server
23 Display
24a-c Inertial measuring units
25 Tilt rotator
26 Digital modified ground surface representation
27 Grid point
28a-d Grid tile
29 Grid point section
30 Three dimensional grid point section representation.
31 Terrain modification logging system
32 Visualized previous digital modified ground surface representation
33 Visualized current digital modified ground surface representation
34 Visualized digital ground surface representation
35 Clay
36 Sand
37 Data log
38 Building site
39 Surface combinator module
41a-d Data communication link
42 Processor
43 Memory
44 Storage
45 Ground fill material
46 Digital ground surface representation
100 Excavator
DMGSR1-5 Digital modified ground surface representation
S1-S3 Method steps
EV Excavated volume

1.-102. (canceled)

103. A method of modifying a terrain comprising a ground surface; wherein said method comprises the steps of:
modifying said terrain to establish a modified terrain and thereby a modified ground surface of said modified terrain;
establishing a digital modified ground surface representation of said modified ground surface; and
automatically storing said digital modified ground surface representation.

104. The method according to claim 103, wherein said method comprises a step of establishing a digital representation of said ground surface of said terrain to obtain a digital ground surface representation; and
wherein said step of automatically storing said digital modified ground surface representation is performed only for geographical positions of said digital modified ground surface representation that comprises elevation data that is lower than elevation data of said digital ground surface representation at corresponding geographical positions.

105. The method according to claim 103, wherein said method comprises a step of displaying said digital modified ground surface representation on a display of a ground modifier.

106. The method according to claim 103, wherein said step of modifying said terrain comprises lifting of ground material of the terrain from one horizontal location to another horizontal location.

107. The method according to claim 103, wherein said digital modified ground surface representation is based on position information obtained from at least one ground modifier of said one or more ground modifiers, and wherein said position information is obtained during said step of modifying said terrain.

108. The method according to claim 103, wherein said digital modified ground surface representation is based on position information obtained from a plurality of ground modifiers, and wherein said method comprises a step of comparing position information obtained from each of said plurality of ground modifiers to select the lowest elevation in each position; wherein said digital modified ground surface is established based on said lowest elevation in each position.

109. The method according to claim 107, wherein said position information represents a tool point position of a tool point of said one or more ground modifiers.

110. The method according to claim 109, wherein said tool point position is based on global position information, and further based on local position information, and wherein said position information of said tool point is determined based on a kinematic model.

111. The method according to claim 109, wherein said digital modified surface representation comprises a plurality of grid points; and wherein said plurality of grid points each represents an area of said terrain; and wherein said grid points comprises elevation data associated with said tool point position of said one or more ground modifiers.

112. The method according to claim 103, wherein said method comprises a step of updating said digital modified ground surface representation when said step of modifying said terrain is repeated; and wherein said step of updating said digital modified ground surface representation is carried out when said modified ground surface is modified in a vertically downward direction along the direction of gravity.

113. The method according to claim 112, wherein said updating of said digital modified ground surface representation is only carried out when said position information comprises elevation data that is lower than elevation data of a corresponding position included in said digital modified ground surface representation.

114. The method according to claim 103, wherein said method comprises a step of selecting a ground material type of said modified ground surface;
and associating as metadata said ground material type with said corresponding digital modified surface ground representation of said modified ground surface.

115. The method according to claim 103, wherein a digital modified ground surface representation established based on a first ground modifier of said one or more ground modifiers and automatically stored on a data server is transmitted from said data server to a second ground modifier and displayed on a user interface.

116. A ground modifier comprising:
a wheelbase;
a ground modification arrangement;
one or more local positioning sensors configured to provide local positioning information of a position of a tool point of said ground modifier; and
a global positioning arrangement configured to provide global positioning information of said ground modifier; and
wherein said ground modifier is configured to carry out said method according to claim 103.

117. The ground modifier according to claim 116, wherein said ground modifier is an excavator further comprising:
a motor;
a transmission;
a body portion comprising a cab;
wherein said ground modification arrangement is moveably fixated to said body portion and wherein said ground modification arrangement comprises:
a boom;
an arm moveably mounted to an end of said boom; and
a bucket moveably mounted to an end of said arm.

118. The ground modifier according to claim 116, wherein at least one local positioning sensor of said one or more local positioning sensors is an inertial measurement unit.

119. The ground modifier according to claim 116, wherein said ground modifier comprises a display configured to display one or more digital modified ground surface representations; and wherein when said display is requested by a user via a user interface to not display said digital modified ground surface representation, said digital modified ground surface representation is still automatically stored.

120. A terrain modification logging system comprising:
a positioning arrangement implementable on a ground modifier comprising:
a tool point, and wherein said positioning arrangement comprises one or more local positioning sensors configured to provide local position information associated with said tool point;
a global positioning arrangement configured to provide global position information associated with said ground modifier; and
a tool point localizing module configured to establish a digital modified ground surface representation of a modified ground surface of a terrain based on said local position information received from said one or more local positioning sensors and based on said global position information received from said global positioning arrangement;
a data server configured to receive and store said established digital modified ground surface representation; and
wherein said terrain modification logging system is configured to perform said method according to claim 103, when said system is implemented on a ground modifier.

121. The method according to claim 109, wherein said tool point position is determined on the basis of geometry of the tool point of a tool of a ground modifier.

122. The method according to claim 112, wherein updating of the digital modified ground surface representation is obtained on the basis of the geometry of the tool point of a tool of a ground modifier and its measured movement relative to a digital ground surface representation about to be modified.
